(19) United States
(12) Patent Application Publication
(10) Pub. No.: US 2024/0147994 A1
(43) Pub. Date: May 9, 2024

(54) ENHANCED YEASTICIDAL EFFICACY OF LACTIC ACID BASED ANTIMICROBIAL HANDWASH

(71) Applicant: ECOLAB USA INC., Saint Paul, MN (US)

(72) Inventors: Dale Larson, Saint Paul, MN (US); Brandon Herdt, Saint Paul, MN (US); Laura Willson, Saint Paul, MN (US)

(21) Appl. No.: 18/489,193

(22) Filed: Oct. 18, 2023

Related U.S. Application Data
(60) Provisional application No. 63/380,007, filed on Oct. 18, 2022.

(51) Int. Cl. A01N 37/36; A01N 25/02; A01N 25/22; A01N 25/30; A01N 31/04; A01P 1/00

(52) U.S. Cl. CPC A01N 37/36; A01N 25/02; A01N 25/22; A01N 25/30; A01N 31/04; A01P 1/00

(57) ABSTRACT

Disclosed herein are antimicrobial hand wash compositions comprising an organic acid, a preservative, and a microbial synergist. In particular, the compositions comprise a carboxylic acid, a carboxylic acid salt preservative, and an alkyl aryl alcohol microbial synergist. Also disclosed are methods of using the same to provide an at least 2 log₁₀ kill of a microbial population, including Candida albicans.

### TECHNICAL FIELD

The present disclosure relates to antimicrobial cleansers, particularly those for a skin surface, with a high degree of yeasticidal activity. The antimicrobial cleansers comprise a combination of an organic acid, a preservative, and a microbial synergist which interact to provide substantially improved micro efficacy against microorganisms, such as C. albicans.

### TECHNICAL BACKGROUND

Effective antimicrobial compositions are desirable products for surface applications, particularly for use on skin and hand surfaces. Microorganisms can present significant health hazards due to infection or contamination. When microorganisms are present on the surface of a substrate, they can replicate rapidly to form colonies. In particular, when the substrate is a skin surface, the risk of pathogen transmission is increased substantially. Skin surfaces such as hands a a primary means of pathogen transmission, either by transferring a pathogen to another surface or by picking up a pathogen from a touched surface. Sanitizing substances are used to reduce the risk of exposure and dispersion of pathogenic microorganisms found in daily activities, such as bacteria, viruses, fungi, and other microorganisms. In particular, due to regulatory requirements, antimicrobial compositions must also possess yeasticidal efficacy in addition to bactericidal efficacy.

Many traditional antimicrobial compositions do not possess the yeasticidal efficacy required by regulatory standards. Additionally, traditional oxidative germicides like iodine and chlorine dioxide are yeasticidal but are not ideal for use in some situations. For example, these active ingredients may not be desired in some markets because of residue concerns for iodine or chlorate.

There is therefore a need to provide antimicrobial compositions which provide excellent yeasticidal efficacy.

There is a further need to provide antimicrobial compositions that are capable of being applied to a surface without leaving a residue on the surface after application of the composition.

These and other objects, advantages, and features of the present disclosure will become apparent from the following specification taken in conjunction with the claims set forth herein.

### BRIEF SUMMARY

Disclosed herein are compositions providing antimicrobial efficacy, including yeasticidal efficacy suitable for application on a variety of surfaces, such as skin surfaces. Also disclosed herein are methods of making and using the same.

In an embodiment, the compositions are an antimicrobial hand wash composition comprising an organic acid; a preservative; and a microbial synergist. According to a preferred embodiment, the organic acid comprises a carboxylic acid, a sulfonic acid, or a combination thereof. In a still further embodiment, the carboxylic acid comprises lactic acid, citric acid, acetic acid, formic acid, oxalic acid, uric acid, malic acid, tartaric acid, gluconic acid, glucaric acid, ascorbic acid, glutamic acid, levulinic acid, heptanoic acid, octanoic acid, nonanoic acid, decanoic acid, dodecanoic acid, tetradecanoic acid, hexadecenoic acid, octadecanoic acid, benzoic acid, icosanoic acid, or a combination thereof. In an embodiment, the sulfonic acid comprises methanesulfonic acid, ethanedisulfonic acid, 2-ethanesulfonic acid, 2-aminoethanesulfonic acid, toluenesulfonic acid, sodium tetradecyl sulfate, 2-Acrylamido-2-methylpropane sulfonic acid (AMPS), or a combination thereof.

In an embodiment, the preservative comprises a carboxylic acid salt preservative. According to a preferred embodiment, the carboxylic acid salt preservative is a salt of benzoic acid, propanoic acid, sorbic acid, methanoic acid, ethanoic acid, or a combination thereof. In a still further embodiment, the preservative comprises calcium proprionate, sodium proprionate, potassium sorbate, sodium benzoate, sodium sorbate, or a combination thereof.

In some embodiments, the microbial synergist comprises an alkyl aryl alcohol. In a preferred embodiment, the alkyl aryl alcohol comprises a primary aryl alcohol, secondary aryl alkyl alcohol, tertiary aryl alkyl alcohol, or a combination thereof. In a still further preferred embodiment, the alkyl aryl alcohol comprises anisyl alcohol, 2-methoxybenzyl alcohol, benzyl alcohol, 2-benzylheptanol, 2-(4-tert.butyl phenyl) ethanol, 2,2-dimethyl-3-phenylpropanol, p-isopropylbenzyl alcohol, 3-(p-Isopropyl)phenyl-2-methyl-1-propanol, β-methoxy benzeneethanol, β-methylpenethyl alcohol, 2-(3-methylphenoxy)ethanol, 2-(3-methylphenyl)ethanol, 2-methyl-4-phenylpentanol, 2-methyl-5-phenylpentanol, 3-methyl-5-phenylpentanol, phenethyl alcohol, 2-phenoxyethanol, 5-phenylpentanol, phenylpropanol, p-tolyl alcohol, o-tolylethanol, 2-p-tolylethanol, β,β,3-trimethyl benzenepropanol, α-Isobutylphenethyl alcohol, α-methylbenzyl alcohol, 3-Methyl-1-phenylbutan-2-ol, 4-Phenyl-3-buten-2-ol, α-propylphenethyl alcohol, benzhydrol, α,α-dimethylphenethyl alcohol, 2-methyl-4-phenyl-2-butanol, 1-phenyl-3-methyl-3-pentanol, 2-phenyl-2-propanol, p-α,α-trimethylbenzyl alcohol, α,α,4-trimethylphenethyl alcohol, or a combination thereof.

In some embodiments, the compositions further comprise an anionic surfactant, a nonionic surfactant, amphoteric surfactant, or a combination thereof. In an embodiment, the anionic surfactant comprises a sulfate, sulfonate, or sulfolaurate. In an embodiment, the nonionic surfactant comprises a glucosamide, EO/PO block copolymer, polyhydroxyfatty acid amide, fatty alcohol, alkylpolysaccharide, or alkoxylated amine. In an embodiment, the amphoteric surfactant comprises cocamidopropyl betaine (CAPB)/coconut alkyl amidopropyl dimethyl betaine, hexadecyl dimethyl betaine, C₁₂₋₁₄ acylamidopropylbetaine, C₈₋₁₄ acylamidohexyldiethyl betaine, C₁₄₋₁₆ acylmethylamidodiethylammonio-1-carboxybutane, C₁₆₋₁₈ acylamidodimethylbetaine, C₁₂₋₁₆ acylamidopentanediethylbetaine, or C₁₂₋₁₆ acylmethylamidodimethylbetaine. In a still further embodiment, the compositions comprise a combination thereof.

In some embodiments, the compositions further comprise a solvent. In an embodiment, the solvent comprises water, an alcohol, an ester, a glycol ether, an amide, a hydrocarbon, or a combination thereof.

In some embodiments, the compositions further comprise an additional functional ingredient comprising a humectant, thickener, emollient, pH modifier, filler, carrier, additional microbial synergist, additional preservative, colorant, dispersant, stabilizing agent, or a combination thereof.

According to an embodiment, the composition comprises from about 0.01 wt. % to about 15 wt. % of the organic acid, from about 0.1 wt. % to about 10 wt. % of the preservative, and from about 0.1 wt. % to 15 wt. % of the microbial synergist.

Also disclosed herein are methods of treating a target comprising: contacting an antimicrobial composition with the target; wherein the antimicrobial composition comprises an organic acid, a preservative, and a microbial synergist; and wherein the contacting lasts for a sufficient time to provide an at least 2 log₁₀ reduction in a microbial population on the target. In some embodiments, the method further comprises a step of diluting the antimicrobial composition with water. In an embodiment, the target is a human skin surface or a non-human skin surface. In an embodiment, the microbial population comprises Escherichia coli, Pseudomonas aeruginosa, Staphylococcus aureus, methicillin-resistant Staphylococcus aureus (MRSA), Candida albicans, Salmonella enterica, Listeria monocytogenes, a human calicivirus (HuCV) a norovirus, or a combination thereof.

While multiple embodiments are disclosed, still other embodiments of the present disclosure will become apparent based on the detailed description, which shows and describes illustrative embodiments of the disclosure. The foregoing summary is illustrative only and is not intended to be in any way limiting. In addition to the illustrative aspects, embodiments, and features described above, further aspects, embodiments, and features of the present technology are apparent from the following drawings and the detailed description, which shows and describes illustrative embodiments of the present technology. Each feature of the technology described herein may be combined with any one or more other features of the disclosure, e.g., the methods may be used with any composition described herein. Accordingly, the drawings and detailed description are to be regarded as illustrative and not restrictive.

### BRIEF DESCRIPTION OF THE DRAWINGS

FIG. 1 shows the log reduction achieved by the compositions of the disclosure in comparison to control formulations.

FIG. 2 shows an additional test of log reduction achieved by the compositions of the disclosure in comparison to control formulations.

FIG. 3 depicts the log reduction achieved by organic acids, a carboxylic acid salt preservative, and a microbial synergist.

FIG. 4 shows the impact of differing concentrations of anionic surfactant on antimicrobial efficacy.

FIG. 5 shows the impact of differing types of anionic surfactants on antimicrobial efficacy.

FIG. 6 depicts the reference inactivation of Modified Vaccinia Virus Ankara (MVS) by 0.7% (w/v) formaldehyde.

FIG. 7 depicts the reference inactivation of Modified Vaccinia Virus Ankara (MVS) by 0.7% (w/v) formaldehyde.

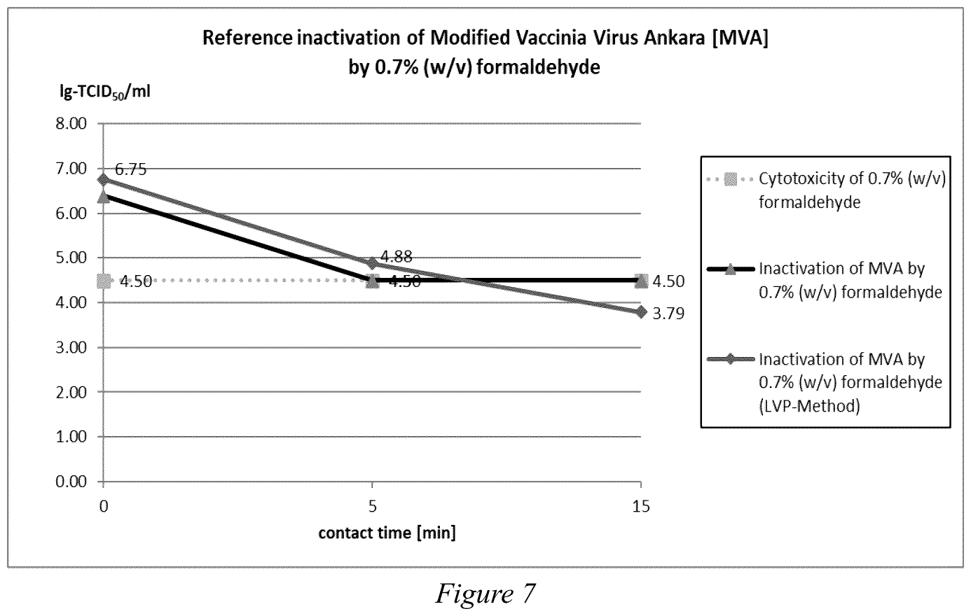

FIG. 8 depicts the reference inactivation of Modified Vaccinia Virus Ankara (MVS) by 0.7% (w/v) formaldehyde.

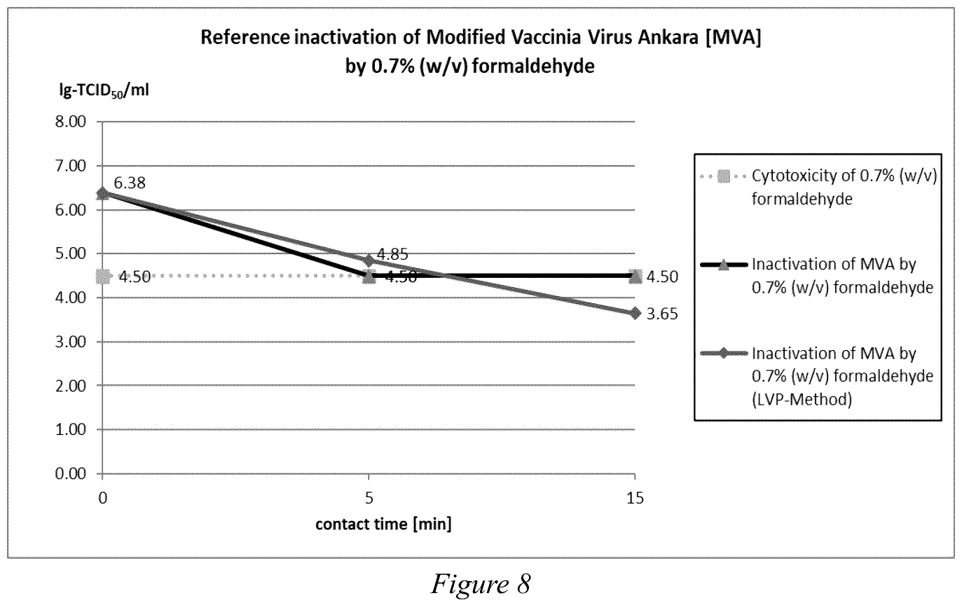

FIG. 9 shows the inactivation of Modified Vaccinia virus Ankara by FC923975 (the formula of Table 10), at 20° C.

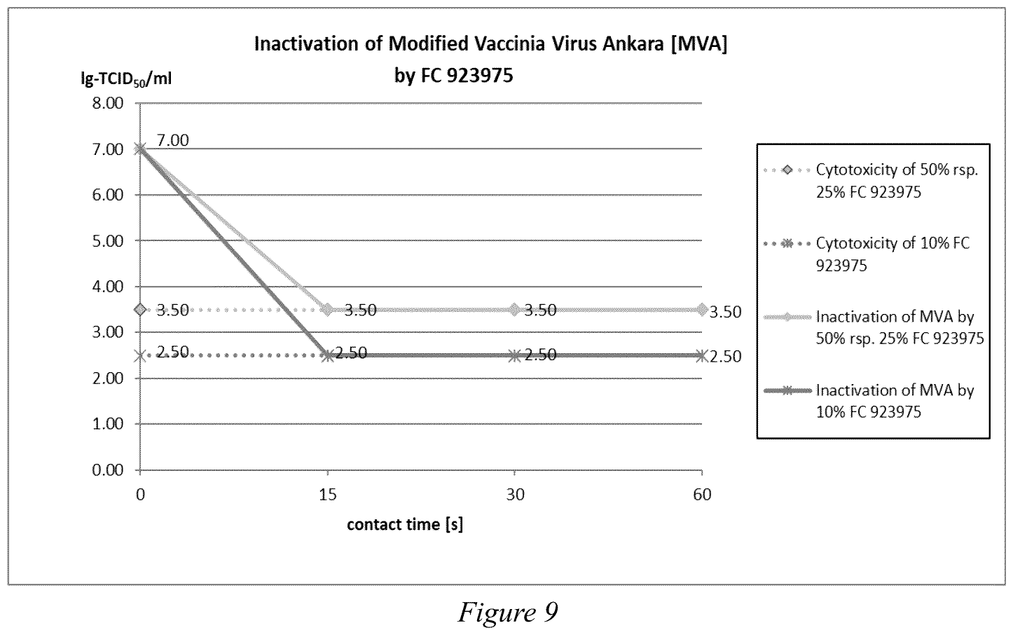

FIG. 10 shows the inactivation of Modified Vaccinia virus Ankara by FC923975 (the formula of Table 10), at 20° C.

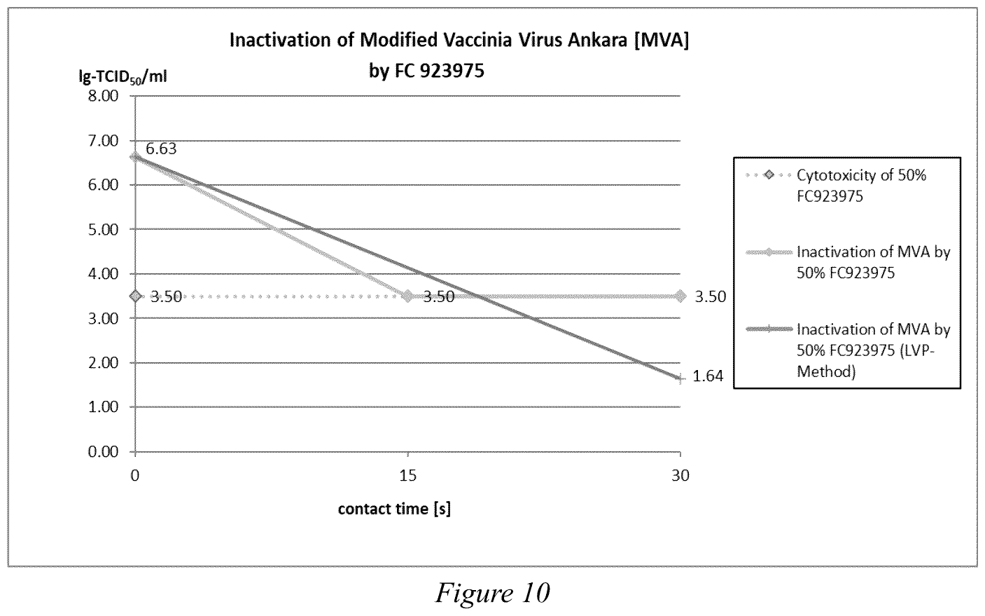

FIG. 11 shows the inactivation of Modified Vaccinia virus Ankara by FC923975 (the formula of Table 10), at 20° C.

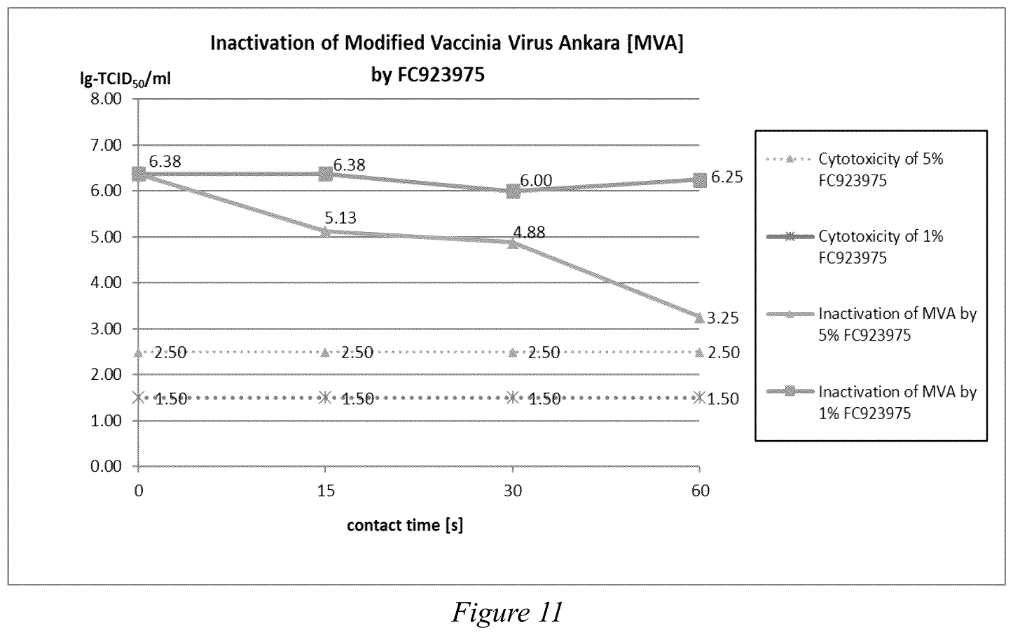

Various embodiments of the present disclosure will be described in detail regarding the drawings. Reference to various embodiments does not limit the scope of the disclosure. Figures represented herein are not limitations to the various embodiments according to the disclosure and are presented for exemplary illustration of the disclosure.

### DETAILED DESCRIPTION OF THE PREFERRED EMBODIMENTS

The present disclosure relates to compositions that provide effective antimicrobial efficacy, including yeasticidal efficacy, and are suitable for application on a variety of surfaces, such as skin surfaces. Also disclosed herein are methods of making and using the same.

It is an advantage that the compositions and methods disclosed herein provide highly effective yeasticidal efficacy.

The embodiments of this disclosure are not limited to particular types of compositions or methods, which can vary. It is further to be understood that all terminology used herein is to describe particular embodiments only and is not intended to be limiting in any manner or scope. For example, as used in this specification and the appended claims, the singular forms “a,” “an” and “the” can include plural referents unless the context indicates otherwise. Unless indicated otherwise, “or” can mean any one alone or any combination thereof, e.g., “A, B, or C” means the same as any of A alone, B alone, C alone, “A and B,” “A and C,” “B and C” or “A, B, and C.” Further, all units, prefixes, and symbols may be denoted in its SI accepted form.

Numeric ranges recited within the specification are inclusive of the numbers defining the range and include each integer within the defined range. Throughout this disclosure, various aspects of this disclosure are presented in a range format. It should be understood that the description in range format is merely for convenience and brevity and should not be construed as an inflexible limitation on the scope of the disclosure. Accordingly, the description of a range should be considered to have specifically disclosed all the possible sub-ranges, fractions, and individual numerical values within that range. For example, a description of a range such as from 1 to 6 should be considered to have specifically disclosed sub-ranges such as from 1 to 3, from 1 to 4, from 1 to 5, from 2 to 4, from 2 to 6, from 3 to 6, etc., as well as individual numbers within that range, for example, 1, 2, 3, 4, 5, and 6, and decimals and fractions, for example, 1.2, 3.8, 1½, and 4¾ This applies regardless of the breadth of the range.

So that the present disclosure may be more readily understood, certain terms are first defined. Unless defined otherwise, all technical and scientific terms used herein have the same meaning as commonly understood by one of ordinary skill in the art to which embodiments of the disclosure pertain. Many methods and materials similar, modified, or equivalent to those described herein can be used in the practice of the embodiments of the present disclosure without undue experimentation, the preferred materials and methods are described herein. In describing and claiming the embodiments of the present disclosure, the following terminology will be used in accordance with the definitions set out below.

The terms “a,” “an,” and “the” include both singular and plural referents.

The term “or” is synonymous with “and/or” and means any one member or combination of members of a particular list.

The term “about,” as used herein, refers to variation in the numerical quantity that can occur, for example, through typical measuring techniques and equipment, with respect to any quantifiable variable, including, but not limited to, mass, volume, time, temperature, pH, reflectance, whiteness, etc. Further, given solid and liquid handling procedures used in the real world, there is certain inadvertent error and variation that is likely through differences in the manufacture, source, or purity of the ingredients used to make the compositions or carry out the methods and the like. The term “about” also encompasses amounts that differ due to different equilibrium conditions for a composition resulting from a particular initial mixture. The term “about” also encompasses these variations. Whether or not modified by the term “about,” the claims include equivalents to the quantities.

The term “actives” or “percent actives” or “percent by weight actives” or “actives concentration” are used interchangeably herein and refer to the concentration of those ingredients involved in cleaning expressed as a percentage minus inert ingredients such as water or salts.

As used herein, a solid cleaning composition refers to a cleaning composition in the form of a solid such as a powder, a particle, an agglomerate, a flake, a granule, a pellet, a tablet, a lozenge, a puck, a briquette, a brick, a solid block, a unit dose, or another solid form known to those of skill in the art. The term “solid” refers to the state of the cleaning composition under the expected conditions of storage and use of the solid cleaning composition. In general, it is expected that the cleaning composition will remain in solid form when exposed to temperatures of up to about 100° F. and greater than about 120° F. A cast, pressed, or extruded “solid” may take any form including a block. When referring to a cast, pressed, or extruded solid it is meant that the hardened composition will not flow perceptibly and will substantially retain its shape under moderate stress or pressure or mere gravity, such as for example, the shape of a mold when removed from the mold, the shape of an article as formed upon extrusion from an extruder, and the like. The degree of hardness of the solid cast composition can range from that of a fused solid block, which is relatively dense and hard, for example, like concrete, to a consistency characterized as being malleable and sponge-like, similar to caulking material. In embodiments of the disclosure, the solid compositions can be further diluted to prepare a use solution or added directly to a cleaning application, including, for example, a laundry machine.

As used herein, the term “substantially free” refers to compositions completely lacking the component or having such a small amount of the component that the component does not affect the performance of the composition. The component may be present as an impurity or as a contaminant and shall be less than 0.5 wt. %. In another embodiment, the amount of the component is less than 0.1 wt. % and in yet another embodiment, the amount of component is less than 0.01 wt. %.

As used herein the terms “use solution,” “ready to use,” or variations thereof refer to a composition that is diluted, for example, with water, to form a use composition having the desired components of active ingredients for cleaning. For reasons of economics, a concentrate can be marketed, and an end-user can dilute the concentrate with water or an aqueous diluent to a use solution.

The term “weight percent,” “wt. %,” “percent by weight,” “% by weight,” and variations thereof, as used herein, refer to the concentration of a substance as the weight of that substance divided by the total weight of the composition and multiplied by 100. It is understood that, as used here, “percent,” “%,” and the like are intended to be synonymous with “weight percent,” “wt. %,” etc.

As used herein, the term “soil” refers to polar or non-polar organic or inorganic substances including, but not limited to carbohydrates, proteins, fats, oils, and the like which may or may not contain particulate matter such as mineral clays, sand, natural mineral matter, carbon black, graphite, kaolin, environmental dust, colorant, dyes, polymers, and oils. These substances may be present in their organic state or complexed to a metal to form an inorganic complex. The terms “soil” and “stain” include, but are not limited to, oil-based stains.

As used herein, “substituted” refers to an organic group as defined below (e.g., an alkyl group) in which one or more bonds to a hydrogen atom contained therein are replaced by a bond to non-hydrogen or non-carbon atoms. Substituted groups also include groups in which one or more bonds to carbon(s) or hydrogen(s) atoms replaced by one or more bonds, including double or triple bonds, to a heteroatom. Thus, a substituted group is substituted with one or more substituents, unless otherwise specified. A substituted group can be substituted with 1, 2, 3, 4, 5, or 6 substituents.

Substituted ring groups include rings and ring systems in which a bond to a hydrogen atom is replaced with a bond to a carbon atom. Therefore, substituted cycloalkyl, aryl, heterocyclic, and heteroaryl groups may also be substituted with substituted or unsubstituted alkyl, alkenyl, and alkynyl groups are defined herein.

As used herein, the term “alkyl” or “alkyl groups” refers to saturated hydrocarbons having one or more carbon atoms, including straight-chain alkyl groups (e.g., methyl, ethyl, propyl, butyl, pentyl, hexyl, heptyl, octyl, nonyl, decyl, etc.), cyclic alkyl groups (or “cycloalkyl” or “alicyclic” or “carbocyclic” groups) (e.g., cyclopropyl, cyclopentyl, cyclohexyl, cycloheptyl, cyclooctyl, etc.), branched-chain alkyl groups (e.g., isopropyl, tert-butyl, sec-butyl, isobutyl, etc.), and alkyl-substituted alkyl groups (e.g., alkyl-substituted cycloalkyl groups and cycloalkyl-substituted alkyl groups).

Unless otherwise specified, the term “alkyl” includes both “unsubstituted alkyls” and “substituted alkyls.” As used herein, the term “substituted alkyls” refers to alkyl groups having substituents replacing one or more hydrogens on one or more carbons of the hydrocarbon backbone. Such substituents may include, for example, alkenyl, alkynyl, halogeno, hydroxyl, alkylcarbonyloxy, arylcarbonyloxy, alkoxycarbonyloxy, aryloxy, aryloxycarbonyloxy, carboxylate, alkylcarbonyl, arylcarbonyl, alkoxycarbonyl, aminocarbonyl, alkylaminocarbonyl, dialkylaminocarbonyl, alkylthiocarbonyl, alkoxyl, phosphate, phosphonato, phosphinato, cyano, amino (including alkyl amino, dialkylamino, arylamino, diarylamino, and alkylarylamino), acylamino (including alkylcarbonylamino, arylcarbonylamino, carbamoyl and ureido), imino, sulfhydryl, alkylthio, arylthio, thiocarboxylate, sulfates, alkylsulfinyl, sulfonates, sulfamoyl, sulfonamido, nitro, trifluoromethyl, cyano, azido, heterocyclic, alkylaryl, or aromatic (including heteroaromatic) groups.

In some embodiments, substituted alkyls can include a heterocyclic group. As used herein, the term “heterocyclic group” includes closed ring structures analogous to carbocyclic groups in which one or more of the carbon atoms in the ring is an element other than carbon, for example, nitrogen, sulfur or oxygen. Heterocyclic groups may be saturated or unsaturated. Exemplary heterocyclic groups include, but are not limited to, aziridine, ethylene oxide (epoxides, oxiranes), thiirane (episulfides), dioxirane, azetidine, oxetane, thietane, dioxetane, dithietane, dithiete, azolidine, pyrrolidine, pyrroline, oxolane, dihydrofuran, and furan.

Alkenyl groups or alkenes are straight chain, branched, or cyclic alkyl groups having two to about 30 carbon atoms, and further including at least one double bond. In some embodiments, an alkenyl group has from 2 to about 30 carbon atoms, or typically, from 2 to 10 carbon atoms. Alkenyl groups may be substituted or unsubstituted. For a double bond in an alkenyl group, the configuration for the double bond can be a trans or cis configuration. Alkenyl groups may be substituted similarly to alkyl groups.

Alkynyl groups are straight chain, branched, or cyclic alkyl groups having two to about 30 carbon atoms, and further including at least one triple bond. In some embodiments, an alkynyl group has from 2 to about 30 carbon atoms, or typically, from 2 to 10 carbon atoms. Alkynyl groups may be substituted or unsubstituted. Alkynyl groups may be substituted similarly to alkyl or alkenyl groups.

As used herein, the terms “alkylene”, “cycloalkylene”, “alkynylides”, and “alkenylene”, alone or as part of another substituent, refer to a divalent radical derived from an alkyl, cycloalkyl, or alkenyl group, respectively, as exemplified by —CH₂CH₂CH₂—. For alkylene, cycloalkylene, alkynylene, and alkenylene groups, no orientation of the linking group is implied.

The term “ester” as used herein refers to —RCOOR¹ group. R is absent, a substituted or unsubstituted alkylene, cycloalkylene, alkenylene, alkynylene, arylene, aralkylene, heterocyclylalkylene, or heterocyclylene group as defined herein. R¹ is a substituted or unsubstituted alkyl, cycloalkyl, alkenyl, alkynyl, aryl, aralkyl, heterocyclylalkyl, or heterocyclyl group as defined herein.

The term “amine” (or “amino”) as used herein refers to —RNR¹R² groups. R is absent, a substituted or unsubstituted alkylene, cycloalkylene, alkenylene, alkynylene, arylene, aralkylene, heterocyclylalkylene, or heterocyclylene group as defined herein. R¹ and R² are independently hydrogen, or a substituted or unsubstituted alkyl, cycloalkyl, alkenyl, alkynyl, aryl, aralkyl, heterocyclylalkyl, or heterocyclyl group as defined herein.

The term “amine” as used herein also refers to an independent compound. When an amine is a compound, it can be represented by a formula of RNR¹R² groups, wherein R, R¹, and R² are independently hydrogen, or a substituted or unsubstituted alkyl, cycloalkyl, alkenyl, alkynyl, aryl, aralkyl, heterocyclylalkyl, or heterocyclyl group as defined herein.

The term “alcohol” as used herein refers to —ROH groups. R is absent, a substituted or unsubstituted alkylene, cycloalkylene, alkenylene, alkynylene, arylene, aralkylene, heterocyclylalkylene, or heterocyclylene group as defined herein.

The term “carboxylic acid” as used herein refers to —RCOOH groups. R is absent, a substituted or unsubstituted alkylene, cycloalkylene, alkenylene, alkynylene, arylene, aralkylene, heterocyclylalkylene, or heterocyclylene group as defined herein.

As used herein, the term “free,” “no,” “substantially no” or “substantially free” refers to a composition, mixture, or ingredient that does not contain a particular compound or to which a particular compound or a particular compound-containing compound has not been added. In some embodiments, the reduction and/or elimination of hydrogen peroxide according to embodiments provide hydrogen peroxide-free or substantially-free compositions. Should the particular compound be present through contamination and/or use in a minimal amount of a composition, mixture, or ingredients, the amount of the compound shall be less than about 3 wt. %. More preferably, the amount of the compound is less than 2 wt. %, less than 1 wt. %, and most preferably the amount of the compound is less than 0.5 wt. %.

As used herein, the term “microorganism” refers to any noncellular or unicellular (including colonial) organism. Microorganisms include all prokaryotes. Microorganisms include bacteria (including cyanobacteria), spores, lichens, fungi, protozoa, virinos, viroids, viruses, phages, and some algae. As used herein, the term “microbe” is synonymous with microorganism.

The methods, systems, apparatuses, and compositions disclosed herein may comprise, consist essentially of, or consist of the components and ingredients described herein as well as other ingredients not described herein. As used herein, “consisting essentially of” means that the methods, systems, apparatuses and compositions may include additional steps, components or ingredients, but only if the additional steps, components or ingredients do not materially alter the basic and novel characteristics of the claimed methods, systems, apparatuses, and compositions.

It should also be noted that, as used in this specification and the appended claims, the term “configured” describes a system, apparatus, or other structure that is constructed or configured to perform a particular task or adopt a particular configuration. The term “configured” can be used interchangeably with other similar phrases such as arranged and configured, constructed and arranged, adapted and configured, adapted, constructed, manufactured and arranged, and the like.

The “scope” of the present disclosure is defined by the claims, along with the full scope of equivalents to which such claims are entitled. The scope of the disclosure is further qualified as including any possible modification to any of the aspects and/or embodiments disclosed herein which would result in other embodiments, combinations, sub-combinations, or the like that would be obvious to those skilled in the art.

### Compositions

Exemplary ranges of the compositions are shown in Table 1 below in weight percentage of the solid compositions.

TABLE 1

| | Example | Example | Example |
|---|---|---|---|
| | Embodiment | Embodiment | Embodiment |
| Component | 1 (wt. %) | 2 (wt. %) | 3 (wt. %) |
| Organic Acid | 0.01-15 | 0.1-10 | 0.25-8 |
| Preservative | 0.1-10 | 0.5-5 | 0.3-2 |
| Microbial synergist | 0.1-15 | 0.5-10 | 0.5-5 |
| Anionic Surfactant(s) | 0.5-50 | 1-30 | 1-20 |
| Additional Functional | 0-90 | 0.5-50 | 0.1-30 |
| Ingredients | | | |
| Water | 0-99 | 10-90 | 50-85 |

Additional example embodiments of the compositions are shown in Table 2.

TABLE 2

| | Example | Example | Example |
|---|---|---|---|
| | Embodiment | Embodiment | Embodiment |
| Component | 1 (wt. %) | 2 (wt. %) | 3 (wt. %) |
| Organic Acid | 0.01-15 | 0.1-10 | 0.25-8 |
| Preservative | 0.1-10 | 0.5-5 | 0.3-2 |
| Microbial synergist | 0.1-15 | 0.5-10 | 0.5-5 |
| Anionic Surfactant(s) | 0.5-50 | 1-30 | 1-20 |
| Amphoteric Surfactant(s) | 0-15 | 0.1-10 | 0.5-2 |
| Nonionic Surfactant(s) | 0-30 | 1-15 | 1-5 |
| Solvent(s) | 0-20 | 0.1-10 | 0.25-5 |
| Humectant(s) | 0-10 | 0.1-5 | 0.5-2 |
| Thickener(s) | 0-10 | 0.1-5 | 0.1-2 |
| Emollient | 0-5 | 0.1-3 | 0.1-0.5 |
| Hydrotrope | 0-5 | 0.1-4 | 0.5-3 |
| Additional Functional | 0-90 | 0.5-50 | 0.1-30 |
| Ingredients | | | |
| Water | 0-99 | 10-90 | 50-85 |

The compositions can be provided in a liquid concentrate form. The liquid concentrate compositions may be diluted to form a use solution, e.g., by contacting water with a solid block or by placing a tablet into a dispenser or wash machine. Alternatively, the compositions may be provided in a ready-to-use liquid, also referred to as a use solution or a use liquid, wherein the compositions are ready to be applied to a surface. The compositions disclosed herein may be used in any part of the wash cycle, but preferably during a wash phase, a rinse phase, or as a pre-soak.

A use solution may be prepared from the solid compositions by diluting the composition with water or other diluent (e.g., by contacting the solid with a water source) at a dilution ratio that provides a use solution having desired detersive properties. The typical dilution factor is between approximately 1 and approximately 10,000 but will depend on factors including water hardness, the amount of soil to be removed, and the like. In an embodiment, the composition is diluted at a ratio of between about 1:10 and about 1:10,000 composition to water, inclusive of all integers with this range, e.g., 1:50, 1:100, 1:1,000, and the like. Particularly, the composition is diluted at a ratio of between about 1:100 and about 1:5,000 concentrate to diluent.

### Organic Acid

In an embodiment, the compositions include one or more organic acids, preferably a C₁-C₁₈ organic acid and still more preferably a C₂-C₆ organic acid. An organic acid is an organic compound characterized by having a hydrogen atom that can be released as a proton. Organic acids are typically considered weak acids, when compared to most inorganic acids, and can be classified according to their functional group. Organic acids can contain one or more of a hydroxyl group (—OH), carboxyl group (—COOH), and a sulfo group (—S(═O)₂—OH). In other words, organic acids can include, without limitation, alcohols, carboxylic acids, and sulfonic acids.

Example organic acids suitable for use in the compositions include carboxylic acids, such as alpha hydroxycarboxylic acids. Suitable carboxylic acids include, without limitation, lactic acid, citric acid, acetic acid, formic acid, oxalic acid, uric acid, malic acid, tartaric acid, gluconic acid, glucaric acid, ascorbic acid, glutamic acid, levulinic acid, heptanoic acid, octanoic acid, nonanoic acid, decanoic acid, dodecanoic acid, tetradecanoic acid, hexadecenoic acid, octadecanoic acid, benzoic acid, icosanoic acid, or a combination thereof. In a preferred embodiment, the carboxylic acid is a C₂-C₆ carboxylic acid.

Examples of suitable sulfonic acids include, without limitation, benzene sulfonic acid, naphthalene sulfonic acid, perfluoro sulfonic acid, or a combination thereof. Salts of sulfonic acids (sulfonates) are also suitable. More particularly, suitable sulfonic acids include aliphatic sulfonic acids, aromatic sulfonic acids, methanesulfonic acid, ethanedisulfonic acid, 2-ethanesulfonic acid, 2-aminoethanesulfonic acid, toluenesulfonic acid, sodium tetradecyl sulfate, 2-Acrylamido-2-methylpropane sulfonic acid (AMPS), or a combination thereof. In a preferred embodiment, the organic comprises lactic acid, tartaric acid, or a combination thereof.

The one or more organic acids may be present in an amount of between about 0.01 wt. % to about 15 wt. % of the composition, preferably between about 0.1 wt. % to about 10 wt. %, more preferably between about 0.25 wt. % to about 8 wt. % and still more preferably between about 0.25 wt. % to about 6 wt. %, inclusive of all integers within these ranges.

### Carboxylic Acid Salt Preservative

In an embodiment, the compositions include a carboxylic acid salt preservative. The carboxylic acid salt may function as a preservative by inhibiting the growth of bacteria or fungi. The compositions may further contribute to antimicrobial efficacy through interaction with other components in the compositions.

Examples of suitable carboxylic acid salt preservatives include, without limitation, a calcium salt of a carboxylic acid, a sodium salt of a carboxylic acid, a potassium salt of a carboxylic acid, or a combination thereof. Preferred carboxylic acids include, without limitation, a salt of benzoic acid, propanoic acid, sorbic acid, methanoic acid, ethanoic acid, or a combination thereof. In a preferred embodiment, the carboxylic acid salt is a benzoic acid salt.

In a preferred embodiment, the carboxylic acid salt preservative comprises calcium proprionate, sodium proprionate, potassium sorbate, sodium benzoate, sodium sorbate, or a combination thereof. In a still further preferred embodiment, the carboxylic acid salt is sodium benzoate.

The carboxylic acid salt preservative may be present in an amount of between about 0.1 wt. % to about 10 wt. %, preferably between about 0.1 wt. % to about 5 wt. %, and still more preferably between about 0.2 wt. % to about 2 wt. %, inclusive of all integers within these ranges.

### Alkyl Aryl Alcohol Microbial Synergist

In some embodiments, the compositions include one or more alkyl aryl alcohol (AAA) microbial synergists.

Examples of suitable alkyl aryl alcohols include a primary aryl alcohol, secondary aryl alkyl alcohol, tertiary aryl alkyl alcohol, or a combination thereof.

More particularly, suitable alkyl aryl alcohols include, without limitation, anisyl alcohol, 2-methoxybenzyl alcohol, benzyl alcohol, 2-benzylheptanol, 2-(4-tert.butyl phenyl) ethanol, 2,2-dimethyl-3-phenylpropanol, p-isopropylbenzyl alcohol, 3-(p-Isopropyl)phenyl-2-methyl-1-propanol, β-methoxy benzeneethanol, β-methylpenethyl alcohol, 2-(3-methylphenoxy)ethanol, 2-(3-methylphenyl)ethanol, 2-methyl-4-phenylpentanol, 2-methyl-5-phenylpentanol, 3-methyl-5-phenylpentanol, phenethyl alcohol, 2-phenoxyethanol, 5-phenylpentanol, phenylpropanol, p-tolyl alcohol, o-tolylethanol, 2-p-tolylethanol, β,β,3-trimethyl benzenepropanol, α-Isobutylphenethyl alcohol, α-methylbenzyl alcohol, 3-Methyl-1-phenylbutan-2-ol, 4-Phenyl-3-buten-2-ol, α-propylphenethyl alcohol, benzhydrol, α,α-dimethylphenethyl alcohol, 2-methyl-4-phenyl-2-butanol, 1-phenyl-3-methyl-3-pentanol, 2-phenyl-2-propanol, p-α,α-trimethylbenzyl alcohol, α,α,4-trimethylphenethyl alcohol, or a combination thereof. In a preferred embodiment, the alkyl aryl alcohol microbial synergist is phenylpropanol.

Discussion and evaluation of alkyl aryl alcohol microbial synergists is found, for example, in Belsito, et al., A toxicological and dermatological assessment of aryl alkyl alcohols when used as fragrance ingredients, FOOD & CHEM. TOX. 50 (2012) S52-S99, which is herein incorporated by reference in its entirety.

The one or more alkyl aryl alcohol microbial synergists may be present in the compositions in an amount of between about 0.1 wt. % to about 15 wt. %, preferably between about 0.5 wt. % to about 10 wt. %, and still more preferably between about 0.5 wt. % to about 5 wt. %, inclusive of the integers within these ranges.

### Hydrotrope

In an embodiment, the compositions optionally include one or more hydrotropes. The hydrotrope may be used as a solubilizing agent and/or to increase solubility for organic matter. In an embodiment, the hydrotrope comprises an anionic hydrotrope. Anionic hydrotropes are able to bind the nonionic surfactants and/or polymer surfactants or other components to improve solubility and prevent phase separation. In some embodiments, hydrotropes are low molecular weight aromatic sulfonate materials such as xylene sulfonates, dialkyldiphenyl oxide sulfonate materials, and cumene sulfonates.

Further exemplary anionic hydrotropes include short chain alkyl benzenes, alkyl naphthalenes and alkyl naphthalene sulfonates. In an aspect of the invention, the class of short chain alkyl benzene or alkyl naphthalene hydrotropes includes alkyl benzene sulfonates based on toluene, xylene, and cumene, and alkyl naphthalene sulfonates. These can include sodium xylene sulfonate, sodium toluene sulfonate, sodium cumene sulfonate, potassium toluene sulfonate, ammonium xylene sulfonate, calcium xylene sulfonate, sodium alkyl naphthalene sulfonate, and sodium butylnaphthalene sulfonate. Sodium xylene sulfonate (SXS) is a preferred anionic hydrotrope.

When present, the one or more hydrotropes may be present in an amount of between about 0.01 wt. % to about 5 wt. %, between about 0.1 wt. % to about 4 wt. %, or between about 0.5 wt. % to about 3 wt. %, inclusive of all integers within these ranges.

### Anionic Surfactants

In an embodiment, the compositions include one or more surfactants, preferably at least one anionic surfactant. Anionic surfactants are surface-active substances that are categorized as anionics because the charge on the hydrophobe is negative, or they are anionic surfactants in which the hydrophobic section of the molecule carries no charge unless the pH is elevated to neutrality or above (e.g., carboxylic acids). Carboxylate, sulfonate, sulfate, sulfolaurate, and phosphate are the polar (hydrophilic) solubilizing groups found in anionic surfactants. Of the cations (counter ions) associated with these polar groups, sodium, lithium, and potassium impart water solubility; ammonium and substituted ammonium ions provide both water and oil solubility; and calcium, barium, and magnesium promote oil solubility. In a preferred embodiment, the compositions include at least one anionic sulfonate surfactant.

The at least one anionic surfactant disclosed herein can be an anionic surfactant comprising at least one or more sulfate functional group (—OSO₃H or —OSO₃⁻) or at least one sulfonate functional group (—SO₃H or —SO₃⁻), respectively.

Anionic sulfonate surfactants suitable for use in the present compositions include alkyl sulfonates, the linear and branched primary and secondary alkyl sulfonates, the aromatic sulfonates with or without substituents, and alkyl sulfolaurates. More particularly, examples of suitable anionic sulfonate surfactants include, without limitation, benzene sulfonates such as sodium dodecyl benzene sulfonate (SDBS), alkyl sulfonates, alkylamide sulfonates, alkylaryl sulfonates, α-olefin sulfonates, paraffin sulfonates, alkyl sulfosuccinates, alkyl ether sulfosuccinates, alkylamide sulfosuccinates, alkyl sulfoacetates, alkyl sulfosuccinamates, acyl isethionates, and N-acyltaurates. In an embodiment, the alkyl and acyl groups of these compounds preferably comprise from 14 to 30 carbon atoms, or from 16 to 22 carbon atoms. In an embodiment, the aryl group comprises a phenyl or benzyl group. The sulfonates may be optionally oxyethylenated and comprise from 1 to 50 ethylene oxide units.

Anionic sulfate surfactants suitable for use in the present compositions include alkyl ether sulfates, alkyl sulfates, the linear and branched primary and secondary alkyl sulfates, alkyl ethoxysulfates, fatty oleyl glycerol sulfates, alkyl phenol ethylene oxide ether sulfates, the C₅-C₁₇ acyl-N—(C₁-C₄ alkyl) and —N—(C₁-C₂ hydroxyalkyl) glucamine sulfates, and sulfates of alkylpolysaccharides such as the sulfates of alkylpolyglucoside, and the like, including sodium lauryl sulfate (SLS also available as SULFOPON® 101 UP) and sodium laureth sulfate (SLES, also referred to as sodium lauryl ether sulfate). Also included are the alkyl sulfates, alkyl poly(ethyleneoxy) ether sulfates and aromatic poly(ethyleneoxy) sulfates such as the sulfates or condensation products of ethylene oxide and nonyl phenol (usually having 1 to 6 oxyethylene groups per molecule).

Also included are sulfolaurate anionic surfactants. Examples of suitable sulfolaurate anionic surfactants include, without limitation, alkyl sulfolaurates and salts thereof. Preferred sulfolaurates include sodium methyl 2-sulfolaurate, disodium 2-sulfolaurate, or a combination thereof.

Anionic carboxylate surfactants suitable for use in the present compositions include carboxylic acids (and salts), such as alkanoic acids (and alkanoates), ester carboxylic acids (e.g., alkyl succinates), ether carboxylic acids, sulfonated fatty acids, such as sulfonated oleic acid, and the like. Such carboxylates include alkyl ethoxy carboxylates, alkyl aryl ethoxy carboxylates, alkyl polyethoxy polycarboxylate surfactants and soaps (e.g., alkyl carboxyls).

Secondary carboxylates useful in the present compositions include those which contain a carboxyl unit connected to a secondary carbon. The secondary carbon can be in a ring structure, e.g., as in p-octyl benzoic acid, or as in alkyl-substituted cyclohexyl carboxylates.

The secondary carboxylate surfactants typically contain no ether linkages, no ester linkages and no hydroxyl groups. Further, they typically lack nitrogen atoms in the head-group (amphiphilic portion). Suitable secondary soap surfactants typically contain 11-13 total carbon atoms, although more carbons atoms (e.g., up to 16) can be present. Suitable carboxylates also include acylamino acids (and salts), such as acylgluamates, acyl peptides, sarcosinates (e.g., N-acyl sarcosinates), taurates (e.g., N-acyl taurates and fatty acid amides of methyl tauride), and the like.

Suitable anionic surfactants include alkyl or alkylaryl ethoxy carboxylates of the following formula:

R—O—(CH₂CH₂O)ₙ(CH₂)ₘ—CO₂X (3)

in which R is a C₈ to C₂₂ alkyl group or

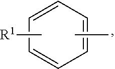

in which R¹ is a C₄-C₁₆ alkyl group; n is an integer of 1-20; m is an integer of 1-3; and X is a counter ion, such as hydrogen, sodium, potassium, lithium, ammonium, or an amine salt such as monoethanolamine, diethanolamine or triethanolamine. In some embodiments, n is an integer of 4 to 10 and m is 1. In some embodiments, R is a C₈-C₁₆ alkyl group. In some embodiments, R is a C₁₂-C₁₄ alkyl group, n is 4, and m is 1.

In other embodiments, R is

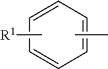

and R¹ is a C₆-C₁₂ alkyl group. In still yet other embodiments, R¹ is a C₉ alkyl group, n is 10 and m is 1.

Such alkyl and alkylaryl ethoxy carboxylates are commercially available. These ethoxy carboxylates are typically available as the acid forms, which can be readily converted to the anionic or salt form. Commercially available carboxylates include Neodox 23-4, a C₁₂₋₁₃ alkyl polyethoxy (4) carboxylic acid (Shell Chemical), and Emcol CNP-110, a C₉ alkylaryl polyethoxy (10) carboxylic acid (Witco Chemical). Carboxylates are also available from Clariant, e.g., the product Sandopan® DTC, a C₁₃ alkyl polyethoxy (7) carboxylic acid.

The one or more anionic surfactants may be present in the compositions individually or in sum in an amount of between about 0.5 wt. % to about 50 wt. %, preferably between about 1 wt. % to about 30 wt. %, and still more preferably between about 1 wt. % to about 20 wt. %, inclusive of all integers within these ranges.

In an embodiment, the compositions include at least two anionic surfactants. In such an embodiment, the compositions may include between about 1 wt. % to about 3 wt. % of a first anionic surfactant and between about 4 wt. % to about 10 wt. % of a second anionic surfactant, inclusive of all integers within these ranges. In a still further embodiment, the compositions include between about 0.5 wt. % to about 5 wt. % of a first anionic surfactant and between about 15 wt. % to about 20 wt. % of a second anionic surfactant, inclusive of all integers within these ranges.

### Amphoteric Surfactants

The compositions of the disclosure optionally include one or more amphoteric surfactants. Amphoteric, or ampholytic, surfactants contain both a basic and an acidic hydrophilic group and an organic hydrophobic group. These ionic entities may be any of anionic or cationic groups described herein for other types of surfactants. A basic nitrogen and an acidic carboxylate group are the typical functional groups employed as the basic and acidic hydrophilic groups. In a few surfactants, sulfonate, sulfate, phosphonate or phosphate provide the negative charge.

Amphoteric surfactants can be broadly described as derivatives of aliphatic secondary and tertiary amines, in which the aliphatic radical may be straight chain or branched and wherein one of the aliphatic substituents contains from about 8 to 18 carbon atoms and one contains an anionic water solubilizing group, e.g., carboxy, sulfo, sulfato, phosphato, or phosphono. Amphoteric surfactants are subdivided into two major classes known to those of skill in the art and described in “Surfactant Encyclopedia” COSMETICS & TOILETRIES, Vol. 104 (2) 69-71 (1989), which is herein incorporated by reference in its entirety. The first class includes acyl/dialkyl ethylenediamine derivatives (e.g., 2-alkyl hydroxyethyl imidazoline derivatives) and their salts. The second class includes N-alkylamino acids and their salts. Some amphoteric surfactants can be envisioned as fitting into both classes.

Amphoteric surfactants can be synthesized by methods known to those of skill in the art. For example, 2-alkyl hydroxyethyl imidazoline is synthesized by condensation and ring closure of a long chain carboxylic acid (or a derivative) with dialkyl ethylenediamine. Commercial amphoteric surfactants are derivatized by subsequent hydrolysis and ring-opening of the imidazoline ring by alkylation—for example with chloroacetic acid or ethyl acetate. During alkylation, one or two carboxy-alkyl groups react to form a tertiary amine and an ether linkage with differing alkylating agents yielding different tertiary amines.

Long chain imidazole derivatives having application in the present disclosure generally have the general formula:

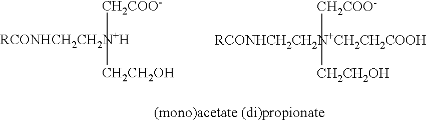

### Neutral pH Zwitterion

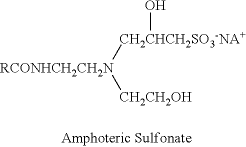

wherein R is an acyclic hydrophobic group containing from about 8 to 18 carbon atoms and M is a cation to neutralize the charge of the anion, generally sodium. Commercially prominent imidazoline-derived amphoterics that can be employed in the present compositions include for example: Cocoamphopropionate, Cocoamphocarboxy-propionate, Cocoamphoglycinate, Cocoamphocarboxy-glycinate, Cocoamphopropyl-sulfonate, and Cocoamphocarboxy-propionic acid. A particularly suitable amphoteric is disodium cocoamphodipropionate, commercially available as Mackam 2CSF. Amphocarboxylic acids can be produced from fatty imidazolines in which the dicarboxylic acid functionality of the amphodicarboxylic acid is diacetic acid or dipropionic acid.

The carboxymethylated compounds (glycinates) described herein above frequently are called betaines. Examples of suitable betaines include long-chain betaine amphoteric surfactants. More particularly, suitable betaines include, without limitation, cocamidopropyl betaine (CAPB)/coconut alkyl amidopropyl dimethyl betaine, hexadecyl dimethyl betaine, C₁₂₋₁₄ acylamidopropylbetaine, C₈₋₁₄ acylamidohexyldiethyl betaine, C₁₄₋₁₆ acylmethylamidodiethylammonio-1-carboxybutane, C₁₆₋₁₈ acylamidodimethylbetaine, C₁₂₋₁₆ acylamidopentanediethylbetaine, C₁₂₋₁₆ acylmethylamidodimethylbetaine, or a combination thereof. In a preferred embodiment, the compositions comprise an amphoteric surfactant comprising cocamidopropyl betaine.

Long chain N-alkylamino acids are readily prepared by reaction RNH₂, in which R═C₈-C₁₈ straight or branched chain alkyl, fatty amines with halogenated carboxylic acids. Alkylation of the primary amino groups of an amino acid leads to secondary and tertiary amines. Alkyl substituents may have additional amino groups that provide more than one reactive nitrogen center. Most commercial N-alkylamine acids are alkyl derivatives of beta-alanine or beta-N(2-carboxyethyl) alanine. Examples of commercial N-alkylamino acid ampholytes having application in this disclosure include alkyl beta-amino dipropionates, RN(C₂H₄COOM)₂ and RNHC₂H₄COOM. In an embodiment, R can be an acyclic hydrophobic group containing from about 8 to about 18 carbon atoms, and M is a cation to neutralize the charge of the anion.

Suitable amphoteric surfactants include those derived from coconut products such as coconut oil or coconut fatty acid. Additional suitable coconut derived surfactants include as part of their structure an ethylenediamine moiety, an alkanolamide moiety, an amino acid moiety, e.g., glycine, or a combination thereof; and an aliphatic substituent of from about 8 to 18 (e.g., 12) carbon atoms. Such a surfactant can also be considered an alkyl amphodicarboxylic acid. These amphoteric surfactants can include chemical structures represented as: C₁₂-alkyl-C(O)—NH—CH₂—CH₂—N⁺(CH₂—CH₂—CO₂Na)₂—CH₂—CH₂—OH or C₁₂-alkyl-C(O)—N(H)—CH₂—CH₂—N⁺(CH₂—CO₂Na)₂—CH₂—CH₂—OH. Disodium cocoampho dipropionate is one suitable amphoteric surfactant and is commercially available under the tradename Miranol™ FBS from Rhodia Inc., Cranbury, N.J. Another suitable coconut derived amphoteric surfactant with the chemical name disodium cocoampho diacetate is sold under the tradename Mirataine™ JCHA, also from Rhodia Inc., Cranbury, N.J.

A typical listing of amphoteric classes, and species of these surfactants, is given in U.S. Pat. No. 3,929,678 issued to Laughlin and Heuring on Dec. 30, 1975. Further examples are given in “Surface Active Agents and Detergents” (Vol. I and II by Schwartz, Perry and Berch). Each of these references are herein incorporated by reference in their entirety.

When present in the compositions, the one or more amphoteric surfactants may be present in an amount of between about 0 wt. % to about 15 wt. %, preferably between about 0.1 wt. % and 10 wt. %, still more preferably between about 0.5 wt. % and 2 wt. %. In an embodiment, the compositions are free of amphoteric surfactants.

### Nonionic Surfactants

In an embodiment, the compositions optionally include one or more nonionic surfactants. Nonionic surfactants are surfactants typically characterized by the presence of an organic hydrophobic group and an organic hydrophilic group and are typically produced by the condensation of an organic aliphatic, alkyl aromatic or polyoxyalkylene hydrophobic compound with a hydrophilic alkaline oxide moiety which in common practice is ethylene oxide or a polyhydration product thereof, polyethylene glycol. Practically any hydrophobic compound having a hydroxyl, carboxyl, amino, or amido group with a reactive hydrogen atom can be condensed with ethylene oxide, or its polyhydration adducts or its mixtures with alkoxylenes such as propylene oxide to form a nonionic surface-active agent. The length of the hydrophilic polyoxyalkylene moiety which is condensed with any particular hydrophobic compound can be readily adjusted to yield a water dispersible or water-soluble compound having the desired degree of balance between hydrophilic and hydrophobic properties.

Useful nonionic surfactants include, without limitation, sugar-based surfactants, particularly glucosamides, which are formed from glucose and fatty acids. In an embodiment, the compositions include one or more glucosamides which are EO-free, sulfate-free, and/or PEG-free. The polar head group of the glucoside and glucosamide classes of surfactants are shown below. Head groups are depicted in their ring open state.

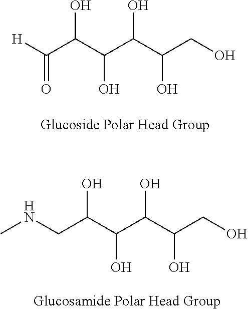

Examples of suitable glucosamides include, without limitation, capryloyl caproyl methyl glucamide, lauroyl myristoyl methyl glucamide, cocoyl methyl glucamide, sunfloweroyl methyl glucamide, coco-betaine, N-coconut acyl-N-methyl glucamine, N—C_{12/14} acyl-N-methyl glucamine, N—C_{8/10} acyl-N-methyl glucamine, or a combination thereof.

Preferred glucosamides are those having less than 18 carbons in the alkyl chain. More preferred are C₈-C₁₆ glucosamides which include. Most preferred are glucosamides having between about 8 and about 10 carbons in the alkyl chain. A particularly preferred glucosamide is capryloyl caproyl methyl glucamide, more particularly a D-Glucitol, 1-deoxy-1-(methylamino)-N—C8-10 acyl derivative, sold commercially as GLUCOTAIN® CLEAR (50%).

An additional group of suitable nonionic surfactants includes block polyoxypropylene-polyoxyethylene polymeric compounds (EO/PO block copolymers) based upon propylene glycol, ethylene glycol, glycerol, trimethylolpropane, and ethylenediamine as the initiator reactive hydrogen compound. Examples of polymeric compounds made from a sequential propoxylation and ethoxylation of initiator are commercially available from BASF Corp. One class of compounds is difunctional (two reactive hydrogens) compounds formed by condensing ethylene oxide with a hydrophobic base formed by the addition of propylene oxide to the two hydroxyl groups of propylene glycol. This hydrophobic portion of the molecule weighs from about 1,000 to about 4,000. Ethylene oxide is then added to sandwich this hydrophobe between hydrophilic groups, controlled by length to constitute from about 10% by weight to about 80% by weight of the final molecule. Another class of compounds is tetra-functional block copolymers derived from the sequential addition of propylene oxide and ethylene oxide to ethylenediamine. The molecular weight of the propylene oxide ranges from about 500 to about 7,000; and the hydrophile, ethylene oxide, is added to constitute from about 10% by weight to about 80% by weight of the molecule.

Condensation products of one mole of alkyl phenol wherein the alkyl chain, of straight chain or branched chain configuration, or of single or dual alkyl constituent, contains from about 8 to about 18 carbon atoms with from about 3 to about 50 moles of ethylene oxide. The alkyl group can, for example, be represented by diisobutylene, di-amyl, polymerized propylene, iso-octyl, nonyl, and di-nonyl. These surfactants can be polyethylene, polypropylene, and polybutylene oxide condensates of alkyl phenols. Examples of commercial compounds of this chemistry are available on the market under the trade names Igepal® manufactured by Rhone-Poulenc and Triton® manufactured by Union Carbide.

Condensation products of one mole of a saturated or unsaturated, straight or branched chain alcohol having from about 6 to about 24 carbon atoms with from about 3 to about 50 moles of ethylene oxide. The alcohol moiety can consist of mixtures of alcohols in the above delineated carbon range, or it can consist of an alcohol having a specific number of carbon atoms within this range. Examples of like commercial surfactant are available under the trade names Lutensol™, Dehydol™ manufactured by BASF, Neodol™ manufactured by Shell Chemical Co. and Alfonic™ manufactured by Vista Chemical Co.

Condensation products of one mole of saturated or unsaturated, straight or branched chain carboxylic acid having from about 8 to about 18 carbon atoms with from about 6 to about 50 moles of ethylene oxide. The acid moiety can consist of mixtures of acids in the above defined carbon atoms range, or it can consist of an acid having a specific number of carbon atoms within the range. Examples of commercial compounds of this chemistry are available on the market under the trade names Disponil or Agnique manufactured by BASF and Lipopeg™ manufactured by Lipo Chemicals, Inc.

In addition to ethoxylated carboxylic acids, commonly called polyethylene glycol esters, other alkanoic acid esters formed by reaction with glycerides, glycerin, and polyhydric (saccharide or sorbitan/sorbitol) alcohols are suitable. All of these ester moieties have one or more reactive hydrogen sites on their molecule which can undergo further acylation or ethylene oxide (alkoxide) addition to control the hydrophilicity of these substances. Care must be exercised when adding these fatty esters or acylated carbohydrates to compositions of the present disclosure containing amylase or lipase enzymes because of potential incompatibility.

Examples of nonionic low foaming surfactants include:

Nonionics which are modified, essentially reversed, by adding ethylene oxide to ethylene glycol to provide a hydrophile of designated molecular weight; and, then adding propylene oxide to obtain hydrophobic blocks on the outside (ends) of the molecule. The hydrophobic portion of the molecule weighs from about 1,000 to about 3,100 with the central hydrophile including 10% by weight to about 80% by weight of the final molecule. These reverse Pluronics™ are manufactured by BASF Corporation under the trade name Pluronic™ R surfactants Likewise, the Tetronic™ R surfactants are produced by BASF Corporation by the sequential addition of ethylene oxide and propylene oxide to ethylenediamine. The hydrophobic portion of the molecule weighs from about 2,100 to about 6,700 with the central hydrophile including 10% by weight to 80% by weight of the final molecule.

Nonionics which are modified by “capping” or “end blocking” the terminal hydroxy group or groups (of multi-functional moieties) to reduce foaming by reaction with a small hydrophobic molecule such as propylene oxide, butylene oxide, benzyl chloride; and short chain fatty acids, alcohols or alkyl halides containing from 1 to about 5 carbon atoms; and mixtures thereof. Also included are reactants such as thionyl chloride which convert terminal hydroxy groups to a chloride group. Such modifications to the terminal hydroxy group may lead to all-block, block-heteric, heteric-block or all-heteric nonionics.

Additional examples of effective low foaming nonionics include:

The alkylphenoxypolyethoxyalkanols of U.S. Pat. No. 2,903,486 issued Sep. 8, 1959, to Brown et al. and represented by the formula

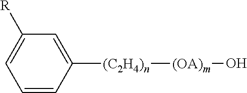

in which R is an alkyl group of 8 to 9 carbon atoms, A is an alkylene chain of 3 to 4 carbon atoms, n is an integer of 7 to 16, and m is an integer of 1 to 10.

The polyalkylene glycol condensates of U.S. Pat. No. 3,048,548 issued Aug. 7, 1962, to Martin et al. having alternating hydrophilic oxyethylene chains and hydrophobic oxypropylene chains where the weight of the terminal hydrophobic chains, the weight of the middle hydrophobic unit and the weight of the linking hydrophilic units each represent about one-third of the condensate.

The defoaming nonionic surfactants disclosed in U.S. Pat. No. 3,382,178 issued May 7, 1968, to Lissant et al. having the general formula Z[(OR)ₙOH]_{z} wherein Z is alkoxylatable material, R is a radical derived from an alkylene oxide which can be ethylene and propylene and n is an integer from, for example, 10 to 2,000 or more and z is an integer determined by the number of reactive oxyalkylatable groups.

The conjugated polyoxyalkylene compounds described in U.S. Pat. No. 2,677,700, issued May 4, 1954, to Jackson et al. corresponding to the formula Y(C₃H₆O)ₙ(C₂H₄O)ₘH wherein Y is the residue of organic compound having from about 1 to 6 carbon atoms and one reactive hydrogen atom, n has an average value of at least about 6.4, as determined by hydroxyl number and m has a value such that the oxyethylene portion constitutes about 10% to about 90% by weight of the molecule.

The conjugated polyoxyalkylene compounds described in U.S. Pat. No. 2,674,619, issued Apr. 6, 1954 to Lundsted et al. having the formula Y[(C₃H₆Oₙ(C₂H₄O)ₘH]ₓ wherein Y is the residue of an organic compound having from about 2 to 6 carbon atoms and containing x reactive hydrogen atoms in which x has a value of at least about 2, n has a value such that the molecular weight of the polyoxypropylene hydrophobic base is at least about 900 and m has value such that the oxyethylene content of the molecule is from about 10% to about 90% by weight. Compounds falling within the scope of the definition for Y include, for example, propylene glycol, glycerin, pentaerythritol, trimethylolpropane, ethylenediamine and the like. The oxypropylene chains optionally, but advantageously, contain small amounts of ethylene oxide and the oxyethylene chains also optionally, but advantageously, contain small amounts of propylene oxide.

Additional conjugated polyoxyalkylene surface-active agents which are advantageously used in the compositions of this disclosure correspond to the formula: P[(C₃H₆O)ₙ(C₂H₄O)ₘH]ₓ wherein P is the residue of an organic compound having from about 8 to 18 carbon atoms and containing x reactive hydrogen atoms in which x has a value of 1 or 2, n has a value such that the molecular weight of the polyoxyethylene portion is at least about 44 and m has a value such that the oxypropylene content of the molecule is from about 10% to about 90% by weight. In either case the oxypropylene chains may contain optionally, but advantageously, small amounts of ethylene oxide and the oxyethylene chains may contain also optionally, but advantageously, small amounts of propylene oxide.

Polyhydroxy fatty acid amide surfactants suitable for use in the present compositions include those having the structural formula R₂CON_{R1}Z in which: R1 is H, C₁-C₄ hydrocarbyl, 2-hydroxy ethyl, 2-hydroxy propyl, ethoxy, propoxy group, or a mixture thereof; R₂ is a C₅-C₃₁ hydrocarbyl, which can be straight-chain; and Z is a polyhydroxy hydrocarbyl having a linear hydrocarbyl chain with at least 3 hydroxyls directly connected to the chain, or an alkoxylated derivative (preferably ethoxylated or propoxylated) thereof. Z can be derived from a reducing sugar in a reductive amination reaction; such as a glycityl moiety.

The alkyl ethoxylate condensation products of aliphatic alcohols with from about 0 to about 25 moles of ethylene oxide are suitable for use in the present compositions. The alkyl chain of the aliphatic alcohol can either be straight or branched, primary or secondary, and generally contains from 6 to 22 carbon atoms.

Fatty alcohol nonionic surfactants, including ethoxylated C₆-C₁₈ fatty alcohols and C₆-C₁₈ mixed ethoxylated and propoxylated fatty alcohols and fatty alcohol polyglycol ethers. Suitable ethoxylated fatty alcohols include the C₆-C₁₈ ethoxylated fatty alcohols with a degree of ethoxylation of from 3 to 50.

Suitable nonionic alkylpolysaccharide surfactants, particularly for use in the present compositions include those disclosed in U.S. Pat. No. 4,565,647, Llenado, issued Jan. 21, 1986. These surfactants include a hydrophobic group containing from about 6 to about 30 carbon atoms and a polysaccharide, e.g., a polyglycoside, hydrophilic group containing from about 1.3 to about 10 saccharide units. Any reducing saccharide containing 5 or 6 carbon atoms can be used, e.g., glucose, galactose and galactosyl moieties can be substituted for the glucosyl moieties. (Optionally the hydrophobic group is attached at the 2-, 3-, 4-, etc. positions thus giving a glucose or galactose as opposed to a glucoside or galactoside.) The intersaccharide bonds can be, e.g., between the one position of the additional saccharide units and the 2-, 3-, 4-, or 6-positions on the preceding saccharide units.

Fatty acid amide surfactants suitable for use the present compositions include those having the formula: R₆CON(R₇)₂ in which R₆ is an alkyl group containing from 7 to 21 carbon atoms and each R₇ is independently hydrogen, C₁-C₄ alkyl, C₁-C₄ hydroxyalkyl, or (C₂H₄O)ₓH, where x is in the range of from 1 to 3.

A useful class of nonionic surfactants include the class defined as alkoxylated amines or, most particularly, alcohol alkoxylated/aminated/alkoxylated surfactants. These nonionic surfactants may be at least in part represented by the general formulae: R²⁰-(PO)_{S}N-(EO)ₜH, R²⁰-(PO)_{S}N-(EO)ₜH(EO)ₜH, and R²⁰-N(EO)ₜH; in which R²⁰ is an alkyl, alkenyl or other aliphatic group, or an alkyl-aryl group of from 8 to 20, preferably 12 to 14 carbon atoms, EO is oxyethylene, PO is oxypropylene, s is 1 to 20, preferably 2-5, t is 1-10, preferably 2-5, and u is 1-10, preferably 2-5. Other variations on the scope of these compounds may be represented by the alternative formula: R²⁰-(PO)_{V}-N[(EO)_{w}H][(EO)_{z}H] in which R²⁰ is as defined above, v is 1 to 20 (e.g., 1, 2, 3, or 4 (preferably 2)), and w and z are independently 1-10, preferably 2-5. These compounds are represented commercially by a line of products sold by Huntsman Chemicals as nonionic surfactants. A suitable chemical of this class includes Surfonic™ PEA 25 Amine Alkoxylate. Suitable nonionic surfactants for the compositions of the disclosure include alcohol alkoxylates, EO/PO block copolymers, alkylphenol alkoxylates, and the like.

The treatise Nonionic Surfactants, edited by Schick, M. J., Vol. 1 of the Surfactant Science Series, Marcel Dekker, Inc., New York, 1983 is an excellent reference on the wide variety of nonionic compounds generally employed in the practice of the present disclosure. A typical listing of nonionic classes, and species of these surfactants, is given in U.S. Pat. No. 3,929,678 issued to Laughlin and Heuring on Dec. 30, 1975. Further examples are given in “Surface Active Agents and detergents” (Vol. I and II by Schwartz, Perry and Berch).

When present, the compositions include one or more nonionic surfactants in an amount of between about 0 wt. % to about 30 wt. %, more preferably between about 1 wt. % and about 15 wt. %, and still more preferably between about 1 wt. % and about 5 wt. %.

### Solvent

In an embodiment, the compositions optionally include one or more solvents. In an embodiment, the solvent comprises water, an alcohol, an ester, a glycol ether, an amide, a hydrocarbon, or a combination thereof. More particularly, suitable solvents include an aromatic alcohol, alkanol amine, ether amine, glycol ether, an ester, or a combination thereof.

Examples of other suitable solvents include, without limitation, lower alkanols, lower alkyl ethers, and lower alkyl glycol ethers. Examples of such useful solvents include methanol, ethanol, propanol, isopropanol and butanol, isobutanol, ethylene glycol, diethylene glycol, triethylene glycol, propylene glycol, hexylene glycol, dipropylene glycol, mixed ethylene-propylene glycol ethers, or a combination thereof. The glycol ethers include lower alkyl (C1-8 alkyl) ethers such as propylene glycol methyl ether, propylene glycol ethyl ether, propylene glycol propyl ether, dipropylene glycol methyl ether, dipropylene glycol ethyl ether, tripropylene glycol methyl ether, ethylene glycol methyl ether, ethylene glycol ethyl ether, ethylene glycol butyl ether, diethylene glycol methyl ether, diethylene glycol butyl ether, ethylene glycol dimethyl ether, ethylene glycol monobutyl ether, or a combination thereof.

Other examples of suitable solvents include acetamidophenol, acetanilide, acetophenone, 2-acetyl-1-methylpyrrole, benzyl acetate, benzyl alcohol, methyl benzyl alcohol, alpha phenyl ethanol, benzyl benzoate, benzyloxyethanol, ethylene glycol phenyl ether, propylene glycol phenyl ether, amyl acetate, amyl alcohol, butanol, 3-butoxyethyl-2-propanol, butyl acetate, n-butyl propionate, cyclohexanone, diacetone alcohol, diethoxyethanol, diethylene glycol methyl ether, diisobutyl carbinol, diisobutyl ketone, dimethyl heptanol, dipropylene glycol tert-butyl ether, ethanol, ethyl acetate, 2-ethylhexanol, ethyl propionate, ethylene glycol methyl ether acetate, hexanol, isobutanol, isobutyl acetate, isobutyl heptyl ketone, isophorone, isopropanol, isopropyl acetate, methanol, methyl amyl alcohol, methyl n-amyl ketone, 2- methyl-1-butanol, methyl ethyl ketone, methyl isobutyl ketone, 1-pentanol, n-pentyl propionate, 1-propanol, n-propyl acetate, n-propyl propionate, propylene glycol ethyl ether, tripropylene glycol methyl ether, tripropylene glycol n-butyl ether, diethylene glycol n-butyl ether acetate, diethylene glycol monobutyl ether, ethylene glycol n-butyl ether acetate, ethylene glycol monobutyl ether, dipropylene glycol monobutyl ether, propylene glycol monobutyl ether, ethyl 3-ethoxypropionate , 2,2,4-trimethyl-1,3-pentanediol monoisobutyrate, diethylene glycol monohexyl ether, ethylene glycol monohexyl ether, diethylene glycol monomethyl ether, diethylene glycol monoethyl ether, ethylene glycol methyl ether acetate, ethylene glycol monomethyl ether, dipropylene glycol monomethyl ether, propylene glycol methyl ether acetate, propylene glycol monomethyl ether, diethylene glycol monopropyl ether, ethylene glycol monopropyl ether, dipropylene glycol monopropyl ether, propylene glycol monopropyl ether, or a combination thereof.

One or more non-water solvent(s) may be present, individually or in sum, in an amount of between about 0 wt. % to about 20 wt. %, more preferably between about 0.1 wt. % to about 10 wt. %, and still more preferably between about 0.25 wt. % to about 5 wt. %, inclusive of all integers within these ranges. Water may be present in an amount of between about 0 wt. % to about 99 wt. %, between about 10 wt. % to about 90 wt. % and still more preferably between about 50 wt. % to about 85 wt. %, inclusive of all integers within these ranges.

### Humectant

The compositions can optionally further comprise one or more humectants. Preferred humectants include, but are not limited to, polyols such as glycerin, glycols (e.g., propylene glycol), and polyethylene glycols. More particularly, suitable humects include hydroxyethyl urea, agarose, urea, sodium PCA, arginine PCA, fructose, glucose, glutamic acid, glycerin, honey, lactose, maltose, polyethylene glycol, sorbitol, a polyquat, or a combination thereof.

The one or more humectants may be present in an amount of between about 0 wt. % to about 10 wt. %, more preferably between about 0.1 wt. % to about 5 wt. %, and still more preferably between about 0.5 wt. % and about 2 wt. %, inclusive of all integers within these ranges.

### Thickener

The compositions may optionally include one or more thickeners or viscosity modifiers. Examples of suitable thickeners include guar and guar derivatives, or modified gum-based polysaccharides, nonionic guars or nonionic guar derivatives, cationic guars or cationic guar derivatives, including for example, a hydroxypropyl-modified guar or hydroxypropyl-modified guar derivative such as guar gum 2 hydroxy-3-(trimethylammonium)propyl ether chloride (e.g., JAGUAR® C 500 N), guar gum 2-hydroxypropyl ether (e.g., MIRAPOL® SURF N and JAGUAR® HP 105), carboxymethyl hydroxypropyl guar gum (e.g., JAGUAR® HP120), and/or a nonionic hydroxypropyl guar such as a nonionic hydroxypropyl guar derived from guar gum (e.g., GUARSAFE® JK-303).

In an embodiment, the gums include guar gums having the below basic structure of guar:

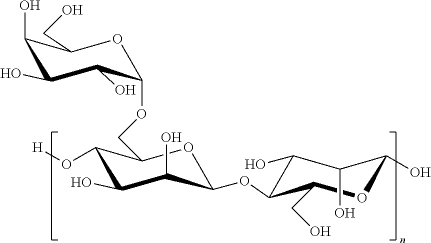

wherein n is any integer suitable to provide a desired molecular weight, including from about 2,000,000 Da or greater, and often between about 2,000,000 and about 3,000,000 Da.

In an embodiment cationic guar or cationic guar derivative (such as cationic guar ethers and cationic guar esters) can be employed as the high molecular weight polymers. Exemplary cationic guars include those obtained according to derivatization techniques such as those described in U.S. Pat. No. 5,756,720, which is herein incorporated by reference in its entirety. Additional examples of suitable guar gums are modified guars such as guar gum 2-hydroxypropyl ether or other cationically modified guars such as guar gum 2 hydroxy-3-(trimethylammonium)propyl ether, including those described in U.S. Pat. No. 9,624,455, which is herein incorporated by reference in its entirety.

Further examples of suitable high molecular weight polymers include polysaccharides that are gums with minimal carboxyl groups on the chain length and/or pendant groups, including diutan gums which are high molecular weight natural microbial polysaccharides. The structure of diutan gums is as shown:

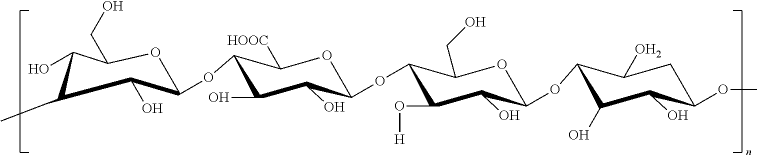

wherein R is

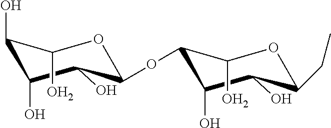

and n is an integer between 1-6000, or between 1500-6000, or between 1900-5800. In an embodiment, the molecular weight of the diutan gums is between about 2.5-5.5×10⁶ g/mol. Diutan gums are water-inactivated or partially water-inactivated. Commercially available diutan gums include KELCO-CRETE 80, KELCO-CRETE 200, KOC617, KELCO-VIS DG and DG-F diutan gums.

Additional suitable thickeners include hydroxypropyl guar, xanthan gum, carrageenan, karaya, polyethylene glycol, polyethylene glycol dialkyl esters, PEG/PPG, cellulose derivatives such as hydroxyethyl cellulose, hydroxypropyl cellulose, hydroxypropyl methyl cellulose, alkyl modified hydroxyethyl cellulose, hydroxyl ethyl propyl, polyquaternium 10, and associative thickeners such as hydrophobically modified ethoxylated urethanes (HEUR), bis-C₁₆-C₂₀ isoalkoxy TMHDI/PEG-90 copolymer, PEG-120 methyl glucose dioleate, PEG-18 glyceryl oleate/cocoate, sorbitan sesquicaprylate, or a combination thereof.

The one or more thickeners may be present in an amount of between about 0 wt. % to about 10 wt. %, more preferably between about 0.1 wt. % to about 5 wt. %, and still more preferably between about 0.1 wt. % and 2 wt. %, inclusive of all integers within these ranges.

### Emollient

The compositions optionally further comprise one or more emollients. Suitable emollients include, without limitation, surfactants, lanolin, isopropyl myristate, glyceryl isostearate, glyceryl caprylate caprate (e.g., STEPAN-MILD® GCC), propylene glycol distearate, vegetable oils, mineral oils, silicone oils, petrolatum, polyglycerol methyl esters, or a combination thereof.

In a preferred embodiment, the emollient is glyceryl caprylate caprate. Beneficially and without being bound by theory, in addition to use as a co-emulsifier in oil-in-water or water-in-oil emulsions, it is though that glyceryl caprylate caprate can also improve viscosity- building properties and enhance foaming properties.

When present, the emollient may be present in an amount of between about 0 wt. % to about 5 wt. %, more particularly between about 0.1 wt. % and 3 wt. %, still more preferably between about 0.25 wt. % and about 0.5 wt. %, inclusive of all integers within these ranges.

### Alkalinity Source

Tin an embodiment, the compositions include one or more sources of alkalinity to aid in soil removal efficacy. The alkalinity source can include an alkali metal carbonate, an alkali metal hydroxide, alkali metal silicate, alkali metal metasilicate, or a combination thereof

Alkali metal carbonates are often referred to as ash-based detergents and most often employ sodium carbonate. Additional alkali metal carbonates include, for example, sodium or potassium carbonate, bicarbonate, sesquicarbonate, or a combination thereof. In an aspect, the alkali metal carbonates are further understood to include metasilicates, silicates, bicarbonates and sesquicarbonates. As described herein, any “ash-based” or “alkali metal carbonate” shall also be understood to include all alkali metal carbonates, metasilicates, silicates, bicarbonates and/or sesquicarbonates, and salts thereof, such as sodium, potassium, and lithium salts.

Alkali metal hydroxides are often referred to as caustic detergents. Examples of suitable alkali metal hydroxides include sodium hydroxide, potassium hydroxide, and lithium hydroxide. Exemplary alkali metal salts include sodium carbonate, potassium carbonate, and mixtures thereof. The alkali metal hydroxides may be added to the composition in any suitable form, including solid beads, an aqueous solution, or a combination thereof. Alkali metal hydroxides are commercially available as a solid in the form of prilled solids or beads having a mix of particle sizes ranging from about 12-100 U.S. mesh, or as an aqueous solution, such as for example, as a 45% and a 50% by weight solution.

In addition to a first alkalinity source, the composition may comprise a second source of alkalinity. In a preferred embodiment, the composition includes sodium carbonate. In a further embodiment, the composition includes sodium carbonate and sodium metasilicate.

An effective amount of one or more alkalinity sources is provided in the detergent composition. An effective amount is referred to herein as an amount that provides a use composition having a pH of between about 8 to about 13, more preferably, between about 9 to about 12.

### Fillers and Carriers

In some embodiments, the compositions can include one or more fillers and/or carriers. Fillers are sometimes generally inert but may cooperate with surfactants to enhance the overall capacity of the composition. In other circumstances, some fillers provide secondary benefits. For example, fillers as used in cleaning compositions may help the composition to flow freely and improve dispersion. Some examples of suitable fillers may include, without limitation, sodium sulfate, sodium chloride, a starch, a sugar, a C₁-C₁₀ alkylene glycol such as propylene glycol, or a combination thereof.

### Additional Surfactants

The compositions may optionally include one or more additional nonionic, semi-polar nonionic, cationic, anionic, zwitterionic, or amphoteric surfactants. In an embodiment, the compositions are free of additional surfactants, such as additional nonionic, semi-polar nonionic, cationic, anionic, zwitterionic, or amphoteric surfactants.

### Semi-Polar Nonionic Surfactants

The semi-polar type of nonionic surface-active agents are another class of nonionic surfactant useful in compositions of the present disclosure. Generally, semi-polar nonionics are high foaming and foam stabilizers, which can limit their application in CIP systems. However, within compositional embodiments of this disclosure designed for high foam cleaning methodology, semi-polar nonionics would have immediate utility. The semi-polar nonionic surfactants include the amine oxides, phosphine oxides, sulfoxides and their alkoxylated derivatives.

Amine oxides are tertiary amine oxides corresponding to the general formula

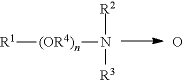

wherein the arrow is a conventional representation of a semi-polar bond; and R¹, R², and R³ may be aliphatic, aromatic, heterocyclic, alicyclic, or combinations thereof. Generally, for amine oxides of detergent interest, R¹ is an alkyl radical of from about 8 to about 24 carbon atoms; R² and R³ are alkyl or hydroxyalkyl of 1-3 carbon atoms or a mixture thereof; R² and R³ can be attached to each other, e.g., through an oxygen or nitrogen atom, to form a ring structure; R⁴ is an alkaline or a hydroxyalkylene group containing 2 to 3 carbon atoms; and n ranges from 0 to about 20.

Useful water soluble amine oxide surfactants are selected from the coconut or tallow alkyl di-(lower alkyl) amine oxides, specific examples of which are dodecyldimethylamine oxide, tridecyldimethylamine oxide, tetradecyldimethylamine oxide, pentadecyldimethylamine oxide, hexadecyldimethylamine oxide, heptadecyldimethylamine oxide, octadecyldimethylaine oxide, dodecyldipropylamine oxide, tetradecyldipropylamine oxide, hexadecyldipropylamine oxide, tetradecyldibutylamine oxide, octadecyldibutylamine oxide, bis(2-hydroxyethyl)dodecylamine oxide, bis(2-hydroxyethyl)-3-dodecoxy-1-hydroxypropylamine oxide, dimethyl-(2-hydroxydodecyl)amine oxide, 3,6,9-trioctadecyldimethylamine oxide and 3-dodecoxy-2-hydroxypropyldi-(2-hydroxyethyl)amine oxide.

Useful semi-polar nonionic surfactants also include the water-soluble phosphine oxides having the following structure:

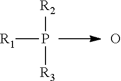

wherein the arrow is a conventional representation of a semi-polar bond; and R¹ is an alkyl, alkenyl or hydroxyalkyl moiety ranging from 10 to about 24 carbon atoms in chain length; and R² and R³ are each alkyl moieties separately selected from alkyl or hydroxyalkyl groups containing 1 to 3 carbon atoms.

Examples of useful phosphine oxides include dimethyldecylphosphine oxide, dimethyltetradecylphosphine oxide, methylethyltetradecylphosphone oxide, dimethyl hexadecyl phosphine oxide, diethyl-2-hydroxyoctyldecylphosphine oxide, bis(2-hydroxyethyl)dodecyl phosphine oxide, and bis(hydroxymethyl)tetradecyl phosphine oxide.

Semi-polar nonionic surfactants useful herein also include the water-soluble sulfoxide compounds which have the structure:

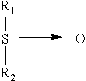

wherein the arrow is a conventional representation of a semi-polar bond; and R¹ is an alkyl or hydroxyalkyl moiety of about 8 to about 28 carbon atoms, from 0 to about 5 ether linkages and from 0 to about 2 hydroxyl substituents; and R² is an alkyl moiety consisting of alkyl and hydroxyalkyl groups having 1 to 3 carbon atoms.

Useful examples of these sulfoxides include dodecyl methyl sulfoxide; 3-hydroxy tridecyl methyl sulfoxide; 3-methoxy tridecyl methyl sulfoxide; and 3-hydroxy-4-dodecoxybutyl methyl sulfoxide.

Semi-polar nonionic surfactants for the compositions of the disclosure include dimethyl amine oxides, such as lauryl dimethyl amine oxide, myristyl dimethyl amine oxide, cetyl dimethyl amine oxide, combinations thereof, and the like. Useful water soluble amine oxide surfactants are selected from the octyl, decyl, dodecyl, isododecyl, coconut, or tallow alkyl di-(lower alkyl) amine oxides, specific examples of which are octyl dimethyl amine oxide, nonyl dimethyl amine oxide, decyl dimethyl amine oxide, undecyl dimethyl amine oxide, dodecyldimethyl amine oxide, iso-dodecyldimethyl amine oxide, lauryl dimethyl amine oxide (sold commercially as Barlox 12), tridecyldimethylamine oxide, tetradecyldimethylamine oxide, pentadecyldimethylamine oxide, hexadecyldimethylamine oxide, heptadecyldimethylamine oxide, octadecyldimethylaine oxide, dodecyldipropylamine oxide, tetradecyldipropylamine oxide, hexadecyldipropylamine oxide, tetradecyldibutylamine oxide, octadecyldibutylamine oxide, bis(2-hydroxyethyl)dodecylamine oxide, bis(2-hydroxyethyl)-3-dodecoxy-l-hydroxypropylamine oxide, dimethyl-(2-hydroxydodecyl)amine oxide, 3,6,9-trioctadecyldimethylamine oxide and 3-dodecoxy-2-hydroxypropyldi-(2-hydroxyethyl)amine oxide.

Suitable nonionic surfactants suitable for use with the compositions of the present disclosure include alkoxylated surfactants. Suitable alkoxylated surfactants include EO/PO copolymers, capped EO/PO copolymers, alcohol alkoxylates, capped alcohol alkoxylates, mixtures thereof, or the like. Suitable alkoxylated surfactants for use as solvents include EO/PO block copolymers, such as the Pluronic and reverse Pluronic surfactants; alcohol alkoxylates, such as Dehypon LS-54 (R-(EO)₅(PO)₄) and Dehypon LS-36 (R-(EO)₃(PO)₆); and capped alcohol alkoxylates, such as Plurafac LF221 and Tegoten EC11; mixtures thereof, or the like.

### Cationic Surfactants

Surface active substances are classified as cationic if the charge on the hydrotrope portion of the molecule is positive. Surfactants in which the hydrotrope carries no charge unless the pH is lowered close to neutrality or lower, but which are then cationic (e.g., alkyl amines), are also included in this group. In theory, cationic surfactants may be synthesized from any combination of elements containing an “onium” structure RnX+Y— and could include compounds other than nitrogen (ammonium) such as phosphorus (phosphonium) and sulfur (sulfonium). In practice, the cationic surfactant field is dominated by nitrogen containing compounds, probably because synthetic routes to nitrogenous cationics are simple and straightforward and give high yields of product, which can make them less expensive.

Cationic surfactants preferably include, more preferably refer to, compounds containing at least one long carbon chain hydrophobic group and at least one positively charged nitrogen. The long carbon chain group may be attached directly to the nitrogen atom by simple substitution; or more preferably indirectly by a bridging functional group or groups in so-called interrupted alkylamines and amido amines. Such functional groups can make the molecule more hydrophilic or more water dispersible, more easily water solubilized by co-surfactant mixtures, or water soluble. For increased water solubility, additional primary, secondary or tertiary amino groups can be introduced, or the amino nitrogen can be quaternized with low molecular weight alkyl groups. Further, the nitrogen can be a part of branched or straight chain moiety of varying degrees of unsaturation or of a saturated or unsaturated heterocyclic ring. In addition, cationic surfactants may contain complex linkages having more than one cationic nitrogen atom.

The surfactant compounds classified as amine oxides, amphoterics and zwitterions are themselves typically cationic in near neutral to acidic pH solutions and can overlap surfactant classifications. Polyoxyethylated cationic surfactants generally behave like nonionic surfactants in alkaline solution and like cationic surfactants in acidic solution.

The simplest cationic amines, amine salts and quaternary ammonium compounds can be schematically drawn thus:

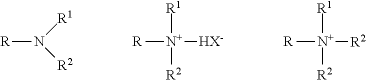

in which R represents an alkyl chain, R′, R″, and R″′ may be either alkyl chains or aryl groups or hydrogen and X represents an anion. The amine salts and quaternary ammonium compounds are suitable for practical use in this disclosure due to their high degree of water solubility.

The majority of large volume commercial cationic surfactants can be subdivided into four major classes and additional sub-groups known to those or skill in the art and described in “Surfactant Encyclopedia,” Cosmetics & Toiletries, Vol. 104 (2) 86-96 (1989). The first class includes alkylamines and their salts. The second class includes alkyl imidazolines. The third class includes ethoxylated amines. The fourth class includes quaternaries, such as alkyl benzyl dimethyl ammonium salts, alkyl benzene salts, heterocyclic ammonium salts, tetra alkylammonium salts, and the like. Cationic surfactants are known to have a variety of properties that can be beneficial in the present compositions. These desirable properties can include detergency in compositions of or below neutral pH, antimicrobial efficacy, thickening or gelling in cooperation with other agents, and the like.

Cationic surfactants useful in the compositions of the present disclosure include those having the formula R¹ₘR²ₓY_{L}Z wherein each R¹ is an organic group containing a straight or branched alkyl or alkenyl group optionally substituted with up to three phenyl or hydroxy groups and optionally interrupted by up to four of the following structures:

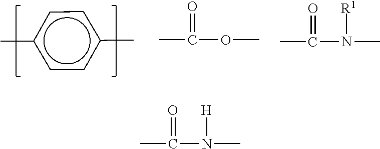

or an isomer or mixture of these structures, and which contains from about 8 to 22 carbon atoms. The R¹ groups can additionally contain up to 12 ethoxy groups. m is a number from 1 to 3. Preferably, no more than one R¹ group in a molecule has 16 or more carbon atoms when m is 2 or more than 12 carbon atoms when m is 3. Each R² is an alkyl or hydroxyalkyl group containing from 1 to 4 carbon atoms or a benzyl group with no more than one R² in a molecule being benzyl, and x is a number from 0 to 11, preferably from 0 to 6. The remainder of any carbon atom positions on the Y group are filled by hydrogens.

Y is a group including, but not limited to:

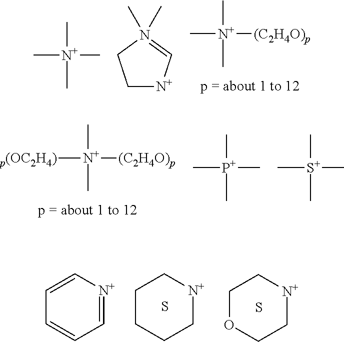

or a mixture thereof. Preferably, L is 1 or 2, with the Y groups being separated by a moiety selected from R¹ and R² analogs (preferably alkylene or alkenylene) having from 1 to about 22 carbon atoms and two free carbon single bonds when L is 2. Z is a water-soluble anion, such as a halide, sulfate, methylsulfate, hydroxide, or nitrate anion, particularly suitable being chloride, bromide, iodide, sulfate or methyl sulfate anions, in a number to give electrical neutrality of the cationic component.

Additional suitable cationic surfactants include those derived from coconut products such as coconut oil or coconut fatty acid. Additional suitable coconut derived surfactants include, for example, complex fatty tertiary amines with cationic surfactant properties, both as free amines and in the salt form. Such surfactants include, but are not limited to N,N-Diethoxylated-N-coco-N-methylammonium chloride (also sometimes referred to as Coconut oil alkyl)bis(2-hydroxyethyl, ethoxylated)methylammonium

Chloride) Such surfactants are commercially available under the trade names Ameenex™, specifically Ameenix™ 1154 and Rewoquat, specifically Rewoquat CQ 100 G.

### Zwitterionic Surfactants

Zwitterionic surfactants can be thought of as a subset of the amphoteric surfactants and can include an anionic charge. Zwitterionic surfactants can be broadly described as derivatives of secondary and tertiary amines, derivatives of heterocyclic secondary and tertiary amines, or derivatives of quaternary ammonium, quaternary phosphonium or tertiary sulfonium compounds. Typically, a zwitterionic surfactant includes a positive charged quaternary ammonium or, in some cases, a sulfonium or phosphonium ion; a negative charged carboxyl group; and an alkyl group. Zwitterionics generally contain cationic and anionic groups which ionize to a nearly equal degree in the isoelectric region of the molecule and which can develop strong “inner-salt” attraction between positive-negative charge centers. Examples of such zwitterionic synthetic surfactants include derivatives of aliphatic quaternary ammonium, phosphonium, and sulfonium compounds, in which the aliphatic radicals can be straight chain or branched, and wherein one of the aliphatic substituents contains from 8 to 18 carbon atoms and one contains an anionic water solubilizing group, e.g., carboxy, sulfonate, sulfate, phosphate, or phosphonate.

Betaine and sultaine surfactants are exemplary zwitterionic surfactants for use herein. A general formula for these compounds is:

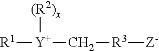

wherein R¹ contains an alkyl, alkenyl, or hydroxyalkyl radical of from 8 to 18 carbon atoms having from 0 to 10 ethylene oxide moieties and from 0 to 1 glyceryl moiety; Y is selected from the group consisting of nitrogen, phosphorus, and sulfur atoms; R² is an alkyl or monohydroxy alkyl group containing 1 to 3 carbon atoms; x is 1 when Y is a sulfur atom and 2 when Y is a nitrogen or phosphorus atom, R³ is an alkylene or hydroxy alkylene or hydroxy alkylene of from 1 to 4 carbon atoms and Z is a radical selected from the group consisting of carboxylate, sulfonate, sulfate, phosphonate, and phosphate groups.

Examples of zwitterionic surfactants having the structures listed above include: 4-[N,N-di(2-hydroxyethyl)-N-octadecylammonio]-butane-1-carboxylate; 5-[S-3-hydroxypropyl-S-hexadecylsulfonio]-3-hydroxypentane-1-sulfate; 3-[P,P-diethyl-P-3,6,9-trioxatetracosanephosphonio]-2-hydroxypropane-1-phosphate; 3-[N,N-dipropyl-N-3-dodecoxy-2-hydroxypropyl-ammonio]-propane-1-phosphonate; 3-(N,N-dimethyl-N-hexadecylammonio)-propane-1-sulfonate; 3 -(N,N-dimethyl-N-hexadecylammonio)-2-hydroxy-propane-1-sulfonate; 4-[N,N-di(2(2-hydroxyethyl)-N(2-hydroxydodecyl)ammonio]-butane-1-carboxylate; 3-[S-ethyl-S-(3-dodecoxy-2-hydroxypropyl)sulfonio]-propane-1-phosphate; 3-[P,P-dimethyl-P-dodecylphosphonio]-propane-1-phosphonate; and S[N,N-di(3-hydroxypropyl)-N-hexadecylammonio]-2-hydroxy-pentane-1-sulfate. The alkyl groups contained in said detergent surfactants can be straight or branched and saturated or unsaturated.

The zwitterionic surfactant suitable for use in the present compositions includes a betaine of the general structure:

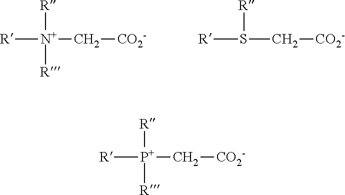

These surfactant betaines typically do not exhibit strong cationic or anionic characters at pH extremes, nor do they show reduced water solubility in their isoelectric range. Unlike “external” quaternary ammonium salts, betaines are compatible with anionics. Examples of suitable betaines include coconut acylamidopropyldimethyl betaine; hexadecyl dimethyl betaine; C₁₂₋₁₄ acylamidopropylbetaine; C₈₋₁₄ acylamidohexyldiethyl betaine; 4-C₁₄₋₁₆ acylmethylamidodiethylammonio-1-carboxybutane; C₁₆₋₁₈ acylamidodimethylbetaine; C₁₂₋₁₆ acylamidopentanediethylbetaine; and C₁₂₋₁₆ acylmethylamidodimethylbetaine.

Sultaines useful in the present disclosure include those compounds having the formula (R(R¹)₂N⁺R²SO³⁻, in which R is a C₆-C₁₈ hydrocarbyl group, each R¹ is typically independently C₁-C₃ alkyl, e.g., methyl, and R² is a C₁-C₆ hydrocarbyl group, e.g., a C₁-C₃ alkylene or hydroxyalkylene group.

### Additional Functional Ingredients

The compositions optionally can further be combined with one or more additional functional ingredients. The functional ingredients provide desired properties and functionalities to the compositions. For the purpose of this application, the term “functional ingredient” includes a material that when dispersed or dissolved in a use or concentrate solution, such as an aqueous solution, provides a beneficial property in a particular use. Some particular examples of functional materials are discussed in more detail below, although the particular materials discussed are given by way of example only, and that a broad variety of other functional ingredients may be used

Additional functional ingredients may include further defoaming agents, bleaching agents or optical brighteners, solubility modifiers, buffering agents, dye transfer inhibiting agents, dispersants, stabilizing agents, sequestrants or chelating agents to coordinate metal ions and control water hardness, microbial synergists or dyes, rheology modifiers or thickeners, hydrotropes or couplers, buffers, solvents, pH buffers, colorants, and the like.

### Colorant

The compositions can optionally comprise a colorant. Preferred colorants include natural and synthetic colorants or dyes. Most preferably the colorant comprises FD&C Blue 1 (Sigma Chemical), FD&C Yellow 5 (Sigma Chemical), Direct Blue 86 (Miles), Fastusol Blue (Mobay Chemical Corp.), Acid Orange 7 (American Cyanamid), Basic Violet 10 (Sandoz), Acid Yellow 23 (GAF), Acid Yellow 17 (Sigma Chemical), Sap Green (Keyston Analine and Chemical), Metanil Yellow (Keystone Analine and Chemical), Acid Blue 9 (Hilton Davis), Sandolan Blue/Acid Blue 182 (Sandoz), Hisol Fast Red (Capitol Color and Chemical), Fluorescein (Capitol Color and Chemical), Acid Green 25 (Ciba-Geigy), or a combination thereof.

In an aspect, the colorant or dye may comprise dyes which are generally recognized as safe. Suitable dyes include, but are not limited to, FDC Blue #1, FDC Blue #2, FDC Green #3, FDC Red #3, FDC Red #4, FDC Red #40, Violet #1, FDC Yellow #5, and FDC Yellow #6.

When present, the colorant may be present in an amount of between about 0.001 wt. % and about 5 wt. %, more preferably between about 0.01 wt. % and about 2 wt. %, most preferably between about 0.1 wt. % and about 1 wt. %, inclusive of all integers within these ranges.

### Additional Microbial Synergist

The compositions may optionally include one or more secondary microbial synergists in addition to the aryl alkyl alcohol microbial synergist. Suitable secondary microbial synergists include natural and synthetic microbial synergists and perfumes. Most preferably the microbial synergist comprises terpenoids such as citronellol, aldehydes such as amyl cinnamaldehyde, a jasmine such as C1S-jasmine or jasmal, vanillin, and the like, or a combination thereof.

### Additional Preservative

The compositions may also optionally include one or more secondary preservatives in addition to the carboxylic acid salt preservative. Suitable secondary preservatives include phenolics, halogen compounds, metal derivatives, amines, alkanolamines, nitro derivatives, biguanides, analides, organosulfur and sulfur-nitrogen compounds, alkyl parabens, and other compounds.

Suitable phenolic compounds include, but are not limited to, pentachlorophenol, orthophenylphenol, chloroxylenol, p-chloro-m-cresol, p-chlorophenol, chlorothymol, m-cresol, o-cresol, p-cresol, isopropyl cresols, mixed cresols, phenoxyethanol, phenoxyethylparaben, phenoxyisopropanol, phenyl paraben, resorcinol, and derivatives thereof. Suitable halogen compounds include but are not limited to iodine-poly(vinylpyrrolidin-onen) complexes, and bromine compounds such as 2-bromo-2-nitropropane-1,3-diol, and derivatives thereof. Suitable amines and nitro containing compounds include, but are not limited to, hexahydro-1,3,5-tris(2-hydroxyethyl)-s-triazine, dithiocarbamates such as sodium dimethyldithiocarbamate, and derivatives thereof. Suitable biguanides include, but are not limited to, polyaminopropyl biguanide and chlorhexidine gluconate. Suitable alkyl parabens include, but are not limited to, methyl, ethyl, propyl and butyl parabens. Other preservatives include, but are not limited to, phospholipid preservatives, such as triglyceride phospholipids. A suitable example is cocamidopropyl phosphatidyl PG-dimonium chloride (e.g., COLA®LIPID C).

When present, the additional preservative(s) may be present in an amount of between about 0 wt. % to about 10 wt. %, more preferably between about 0.1 wt. % to about 5 wt. %, and still more preferably between about 0.1 wt. % and 3 wt. %, inclusive of all integers within these ranges.

### Additional Antimicrobial Agents

In some embodiments, the compositions can optionally include an additional antimicrobial or sanitizing agent. Sanitizing agents also known as antimicrobial agents are chemical compositions that can be used in a solid functional material to prevent microbial contamination and deterioration of material systems, surfaces, etc. Generally, these materials fall in specific classes including phenolics, halogen compounds, quaternary ammonium compounds, metal derivatives, amines, alkanol amines, nitro derivatives, analides, organosulfur and sulfur-nitrogen compounds and miscellaneous compounds. However, in an embodiment the compositions are free of additional antimicrobial agents.

Some examples of common antimicrobial agents include phenolic antimicrobials such as pentachlorophenol, orthophenylphenol, a chloro-p-benzylphenol, p-chloro-m-xylenol. Halogen containing antibacterial agents include sodium trichloroisocyanurate, sodium dichloro isocyanate (anhydrous or dihydrate), iodine-poly(vinylpyrolidinone) complexes, bromine compounds such as 2-bromo-2-nitropropane-1,3-diol, and quaternary ammonium compounds, such as benzalkonium chloride, didecyldimethyl ammonium chloride, dialkyl dimethyl ammonium chloride, alkyl dimethyl benzyl ammonium chloride, choline diiodochloride, tetramethyl phosphonium tribromide, or a combination thereof. Other antimicrobial compositions such as hexahydro-1,3,5-tris(2-hydroxyethyl)-s-triazine, dithiocarbamates such as sodium dimethyldithiocarbamate.

### Methods of Treating a Target

In an aspect, the present disclosure is directed to a method for treating a surface or a target, which method comprises contacting a surface or a target with an effective amount of the cleaning compositions, wherein the contacting step lasts for sufficient time to stabilize or reduce a microbial population on the surface or target.

In a further embodiment, methods of cleaning a skin surface are provided, wherein the method comprises contacting the cleaning compositions disclosed herein to the skin surface, wherein the contacting lasts for a sufficient time to stabilize or reduce a microbial population on the surface. In an embodiment, the skin surface is from a mammal. In a still further embodiment, the skin surface is from a non-human animal.

In an embodiment, the microbial population is a gram positive or gram negative bacteria, a fungus, a virus, or a combination thereof. In a further embodiment, the microbial population comprises Escherichia coli, Pseudomonas aeruginosa, Staphylococcus aureus, methicillin-resistant Staphylococcus aureus (MRSA), Candida albicans, Salmonella enterica, Listeria monocytogenes, a human calicivirus (HuCV) a norovirus, or a combination thereof.

In some embodiments the methods further comprise a rinsing step, wherein the surface to be cleaned is rinsed after the surface is contacted with the composition.

The contacting step may last for a suitable period of time, for example at least about 10 second and up to several hours. More preferably, the contacting lasts for a period of between about 10 seconds to about 3 hours, between about 20 seconds to about 1 hour, or between about 30 seconds to about 30 minutes.

The contacting preferably reduces or eliminates one or more microbes or a microbial population. In an embodiment, the composition provides an at least 2 log₁₀ reduction in a microbial population, an at least 3 log₁₀ reduction in a microbial population, an at least 4 log₁₀ reduction in a microbial population, or an at least 5 log₁₀ reduction in a microbial population.

### EXAMPLES

Embodiments of the present invention are further defined in the following non-limiting Examples. It should be understood that these Examples, while indicating certain embodiments of the invention, are given by way of illustration only. From the above discussion and these Examples, one skilled in the art can ascertain the essential characteristics of this invention, and without departing from the spirit and scope thereof, can make various changes and modifications of the embodiments of the invention to adapt it to various usages and conditions. Thus, various modifications of the embodiments of the invention, in addition to those shown and described herein, will be apparent to those skilled in the art from the foregoing description. Such modifications are also intended to fall within the scope of the appended claims.

### Test Materials

Materials used in the following examples are provided herein, including chemical name and class along with an example of how the material is commercially sold:

High molecular weight nonionic thickener, in particular a high molecular weight hydroxpropyl (0.6 DS) guar nonionic thickener. Sold commercially as JAGUAR HP-105, CAS 39421-75-5.

Organic acid, in particular C₂-C₆ organic acids, such as lactic acid and tartaric acid.

Carboxylic acid salt preservative, in particular an aromatic carboxylic acid salt, such as sodium benzoate.

Sulfate anionic surfactant, including sodium laureth sulfate (SLES (70%)) and sodium lauryl sulfate (SLS (30%)).

Hydrotrope, including xylene sulfonates such as sodium xylene sulfonate (SXS (30%)). Sold commercially as STEPANATE® SXS.

Sulfolaurate anionic surfactant, including sodium methyl 2-sulfolaurate and disodium 2-sulfolaurate. Sold commercially as ALPHA-STEP® PC-48, CAS 149458-07-1.

Long-chain betaine amphoteric surfactant, including cocamidopropyl betaine (CAPB).

Sugar-derived nonionic surfactant, including capryloyl caproyl methyl glucamide and more particularly a D-Glucitol, 1-deoxy-1-(methylamino)-, N—C8-10 acyl derivative. Sold commercially as GLUCOTAIN® CLEAR (50%).

Solvent, including an aromatic alcohol such as benzyl alcohol, and/or a glycol, such as hexylene glycol and propylene glycol.

Aryl alkyl alcohol microbial synergist, including phenyl propanol

Polyol humectant, including glycerin

Phospholipid preservative, including a triglyceride phospholipid such as Cocamidopropyl Phosphatidyl PG-Dimonium Chloride. Sold commercially as COLA®LIPID C.

Emollient ester, including glyceryl caprylate/caprate. Sold commercially as STEPAN-MILD® GCC.

### Test Protocol

In each of the examples described herein, antimicrobial efficacy was evaluated using the EN 1650 test protocol, titled “Chemical disinfectants and antiseptics—Quantitative suspension test for the evaluation of fungicidal activity of chemical disinfectants and antiseptics used in food, industrial, domestic, and institutional areas.” This particular protocol is a European Standard used to determine the anti-fungal efficacy of chemical disinfectants and sanitizers used in food, industrial, and institutions. The testing protocol corresponds to the ASTM E2315 Liquid Suspension Time-Kill Test.

According to this protocol, fungal cultures comprising Candida albicans were grown and then inoculated into the formulations which are being evaluated. Test formulations were prepared according to the relevant Tables in the examples. Minimum contact times of 30 seconds and 60 seconds were selected. Test formulations were then added to aqueous suspensions of the fungal culture. At the selected time intervals, an aliquot was removed from the aqueous suspension and viable organisms were recovered from the same. The number of surviving organisms in the aliquot was counted and the total number of surviving organisms was estimated by multiplying the dilution factor of the aqueous suspension to arrive at cfu/mL of suspension. This count was then converted to logio reduction. An at least 2 log₁₀ reduction was considered a passing score.

### Example 1

Formulations evaluating the use of one or more organic acids as effective antimicrobial agents for cleaning compositions were prepared according to the Tables below.

TABLE 3

| | Formulation (wt. %) | | | | | | | | | |
|---|---|---|---|---|---|---|---|---|---|---|
| | LES | LES | LES | LES | LES | LES | LES | LES | LES | LES |
| Component | 3O | 4N | 4P | 6C | 7H | 7K | 7N | 7Q | 8B | 9C |
| Water | 85.73 | 85.50 | 77.50 | 70.33 | 71.33 | 71.33 | 72.33 | 73.33 | 80.67 | 83.74 |
| Organic acid | 2.27 | 3.00 | 3.00 | 4.00 | 4.00 | 4.00 | 4.00 | 4.00 | 1.00 | 2.31 |
| (Lactic Acid) | | | | | | | | | | |
| Organic Acid | 2.00 | 3.00 | 3.00 | | | | | | | |
| (Tartaric Acid) | | | | | | | | | | |
| Preservative | 1.00 | 0.50 | 0.50 | 1.00 | 1.00 | 1.00 | 1.00 | 1.00 | 1.00 | 1.00 |
| (Carboxylic acid | | | | | | | | | | |
| salt) | | | | | | | | | | |
| Sulfate anionic | 8.00 | 8.00 | 8.00 | | | | | | | |
| surfactant | | | | | | | | | | |
| (SLES 70%) | | | | | | | | | | |
| Sulfate anionic | | | 3.00 | 18.67 | 18.67 | 18.67 | 18.67 | 18.67 | 8.33 | 8.33 |
| surfactant | | | | | | | | | | |
| (SLS 30%) | | | | | | | | | | |
| Betaine | 1.00 | | | | | | | | | |
| amphoteric | | | | | | | | | | |
| surfactant (CAPB) | | | | | | | | | | |
| Hydrotrope | | | | 1.00 | | | | | 2.50 | |
| (SXS 30%) | | | | | | | | | | |
| Solvent (Benzyl | | | 3.00 | 3.00 | | | | | | |
| Alcohol) | | | | | | | | | | |
| Microbial | | | | | 3.00 | 3.00 | 2.00 | 1.00 | 3.00 | 1.12 |
| synergist (Phenyl | | | | | | | | | | |
| Propanol) | | | | | | | | | | |
| Humectant | 1.00 | | 1.00 | 1.00 | 1.00 | 1.00 | 1.00 | 1.00 | 1.00 | 1.00 |
| (Glycerin) | | | | | | | | | | |
| Solvent (Hexylene | 1.00 | | 1.00 | 1.00 | 1.00 | 1.00 | 1.00 | 1.00 | 2.50 | 2.50 |
| Glycol) | | | | | | | | | | |
| Total | 102 | 100 | 100 | 100 | 100 | 100 | 100 | 100 | 100 | 100 |
| pH | 2.59 | 2.17 | 2.06 | 2.98 | 2.96 | 3.50 | 3.49 | 3.53 | 4.06 | 3.44 |
| Log Reduction | 1.70 | 1.41 | 2.36 | 3.27 | 4.13 | 3.81 | 2.52 | 1.81 | 5.41 | 3.19 |
| (60 sec) | | | | | | | | | | |

TABLE 4

| | Formulation (wt. %) | | | | |
|---|---|---|---|---|---|
| | LES | LES | LES | LES | LES |
| Component | 10L | 10O | 10R | 11F | 11M |
| Water | 78.27 | 83.03 | 80.02 | 77.21 | 91.60 |
| High molecular weight nonionic thickener | | | | 0.25 | 0.40 |
| Organic acid (Lactic Acid) | 0.78 | 0.80 | 0.82 | 1.74 | 1.06 |
| Organic Acid (Tartaric Acid) | | | | | |
| Preservative (Carboxylic acid salt) | 1.50 | 1.50 | 1.50 | 1.50 | 1.50 |
| Sulfate anionic surfactant (SLES 70%) | | 3.57 | | | |
| Sulfate anionic surfactant (SLS 30%) | 8.33 | | | | |
| Sulfolaurate anionic surfactant (sodium methyl 2- | | | 6.58 | 15.79 | 4.00 |
| sulfolaurate, disodium 2-sulfolaurate) | | | | | |
| Nonionic surfactant (e.g., capryloyl caproyl | 5.00 | 5.00 | 5.00 | | |
| methyl glucamide) | | | | | |
| Hydrotrope (SXS 30%) | | | | | |
| Solvent (Benzyl Alcohol) | | | | | |
| Microbial synergist (Phenyl Propanol) | 3.00 | 3.00 | 3.00 | 2.00 | 0.75 |
| Humectant (Glycerin) | 1.00 | 1.00 | 1.00 | 1.00 | 1.00 |
| Solvent (Hexylene Glycol) | 1.50 | 1.50 | 1.50 | 1.50 | 0.75 |
| Preservative (Triglyceride phospholipid) | 1.00 | 1.00 | 1.00 | 0.50 | |
| Emollient (Glyceryl caprylate) | 0.40 | 0.40 | 0.40 | 0.25 | |
| | 100.78 | 100.80 | 100.82 | 101.74 | 101.06 |
| pH | 5.02 | 4.99 | 4.99 | 4.01 | 4.02 |
| Log Reduction (60 sec) | 1.77 | 1.89 | 2.26 | >4.17 | 2.21 |

Table 3 and Table 4 show that the compositions provide excellent antimicrobial efficacy, particularly formulation LES 11F, which includes a carboxylic acid salt preservative, a propanol microbial synergist, an organic acid, and a sulfolaurate anionic surfactant.

### Example 2

Further organic acid-based cleaning compositions were prepared according to the formulas of Table 5 and Table 6. Their antimicrobial efficacy was evaluated. The results of this evaluation are shown in Table 5 and Table 6.

TABLE 5

| | Formulation (wt. %) | | | |
|---|---|---|---|---|
| | LES | LES | LES | LES |
| Component | 12A | 12O | 12E | 12G |
| Water | 81.69 | 81.75 | 76.68 | 89.24 |
| High molecular weight nonionic | 0.25 | 0.25 | 0.25 | 0.40 |
| thickener | | | | |
| Organic Acid | 0.56 | 2.50 | 1.82 | 1.36 |
| Preservative (Carboxylic acid salt) | 1.50 | 1.00 | 1.50 | 1.50 |
| Sulfolaurate anionic surfactant | 9.00 | | 15.00 | 4.00 |
| (sodium methyl 2-sulfolaurate, | | | | |
| disodium 2-sulfolaurate) | | | | |
| Sulfate anionic surfactant (SLS | | 10.00 | | |
| 30%) | | | | |
| Hydrotrope (SXS 30%) | 1.00 | 1.00 | | 1.00 |
| Solvent (Hexylene Glycol) | 1.00 | 1.00 | 1.00 | 0.75 |
| Humectant (Glycerin) | 1.00 | 1.00 | 1.00 | 1.00 |
| Preservative (triglyceride | 1.00 | 0.50 | 0.50 | |
| phospholipid) | | | | |
| Emollient (Glyceryl caprylate) | | | 0.25 | |
| Microbial synergist (Phenyl | 3.00 | 1.00 | 2.00 | 0.75 |
| Propanol) | | | | |
| Total | 100.00 | 100.00 | 100.00 | 100.00 |
| pH | 5.01 | 3.17 | 4.00 | 4.00 |
| Log Reduction (30 sec) | 2.40 | 2.70 | 2.05 | 2.59 |

TABLE 6

| | Formulation (wt. %) | | |
|---|---|---|---|
| | LES | LES | LES |
| Component | 15D | 15E | 15S |
| Water | 86.46 | 81.75 | 80.75 |
| High molecular weight nonionic thickener | 0.25 | 0.25 | 0.25 |
| Preservative (Carboxylic acid salt) | 1.50 | 1.50 | 1.50 |
| Sulfate anionic surfactant (SLS 30%) | | 10.00 | 10.00 |
| Sulfate anionic surfactant (SLES 70%) | 4.29 | | |
| Hydrotrope (SXS 30%) | 2.00 | 1.00 | 2.00 |
| Solvent (Propylene glycol) | 1.00 | 1.00 | 1.00 |
| Humectant (Glycerin) | 1.00 | 1.00 | 1.00 |
| Microbial synergist (Phenyl Propanol) | 3.00 | 2.00 | 1.00 |
| Organic Acid (Lactic acid) | 0.50 | 1.50 | 2.50 |
| | 100.00 | 100.00 | 100.00 |
| pH | 4.86 | 4.00 | 3.54 |
| Log Reduction (30 sec) | 2.75 | 3.76 | 2.36 |

Table 5 and Table 6 show that the example formulations provide good antimicrobial efficacy, and particularly formulation LES15E, which provides very good antimicrobial efficacy.

### Example 3

The concentration and type of surfactant was evaluated for surfactant impact on antimicrobial efficacy. In particular, formulations with varying degrees of surfactant concentrations were prepared according to Table 7.

TABLE 7

| | Formulation (wt. %) | | |
|---|---|---|---|
| | LES | LES | LES |
| Component | 12M | 12N | 12O |
| Water | 86.75 | 84.25 | 81.75 |
| Thickening agent (high molecular weight | 0.25 | 0.25 | 0.25 |
| hydroxypropyl nonionic thickener) | | | |
| Organic acid | 2.50 | 2.50 | 2.50 |
| Preservative | 1.00 | 1.00 | 1.00 |
| Sulfate anionic surfactant (SLS 30%) | 5.00 | 7.50 | 10.00 |
| Hydrotrope (SXS 30%) | 1.00 | 1.00 | 1.00 |
| Solvent (Hexylene Glycol) | 1.00 | 1.00 | 1.00 |
| Humectant | 1.00 | 1.00 | 1.00 |
| Preservative (triglyceride phospholipid) | 0.50 | 0.50 | 0.50 |
| Microbial synergist | 1.00 | 1.00 | 1.00 |
| Total | 100.00 | 100.00 | 100.00 |
| pH | 2.96 | 3.03 | 3.17 |
| Log Reduction (30 sec) | 4.25 | 3.20 | 2.70 |

As shown in Table 7, the compositions of the disclosure may preferably include between about 1 wt. % and about 6 wt. %, when the organic acid, preservative, and microbial synergist are also each present in a range of about 0.5 wt. % to about 5 wt. %.

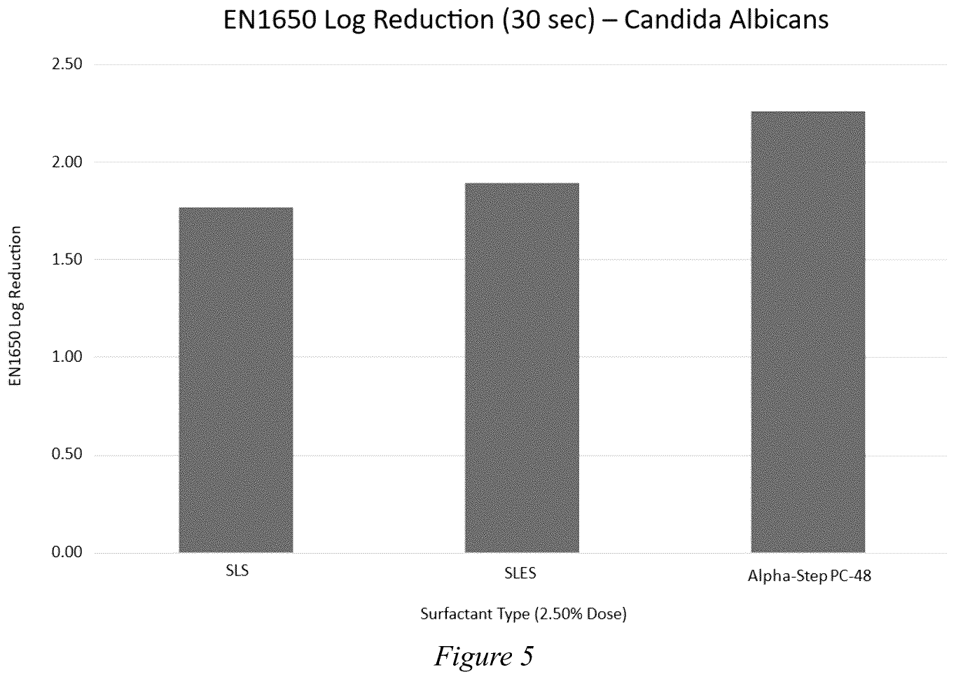

Additionally, formulations with varying degrees of surfactant types were prepared according to Table 8. The log reduction results are also shown in Table 8 and in FIG. 5.

TABLE 8

| | LES | LES | LES |
|---|---|---|---|
| | 10L | 10O | 10R |
| Water | 78.27 | 83.03 | 80.02 |
| Organic Acid (e.g., lactic acid) | 0.78 | 0.80 | 0.82 |
| Preservative (Carboxylic acid salt) | 1.50 | 1.50 | 1.50 |
| Sulfate anionic surfactant (SLS 30%) | 8.33 | | |
| Sulfate anionic surfactant (SLES 70%) | | 3.57 | |
| Sulfolaurate anionic surfactant (sodium | | | 6.58 |
| methyl 2-sulfolaurate) | | | |
| Foaming agent, sugar-based surfactant | 5.00 | 5.00 | 5.00 |
| Nonionic surfactant (e.g., capryloyl | 1.50 | 1.50 | 1.50 |
| caproyl methyl glucamide) | | | |
| Humectant | 1.00 | 1.00 | 1.00 |
| Preservative (triglyceride phospholipid) | 1.00 | 1.00 | 1.00 |
| Emollient (Glyceryl caprylate) | 0.40 | 0.40 | 0.40 |
| Microbial synergist | 3.00 | 3.00 | 3.00 |
| | 100.78 | 100.80 | 100.82 |
| Target pH | 5.00 | 5.00 | 5.00 |
| pH | 5.02 | 4.99 | 4.99 |
| Log Reduction | 1.77 | 1.89 | 2.26 |

As shown in Table 8 and FIG. 5, sulfate, sulfonate, and sulfolaurate anionic surfactants beneficially contribute to the antimicrobial efficacy of the compositions. A preferred type of anionic surfactant is a sulfolaurate anionic surfactant, such as sodium methyl 2-sulfolaurate and/or disodium 2-sulfolaurate.

### Example 4

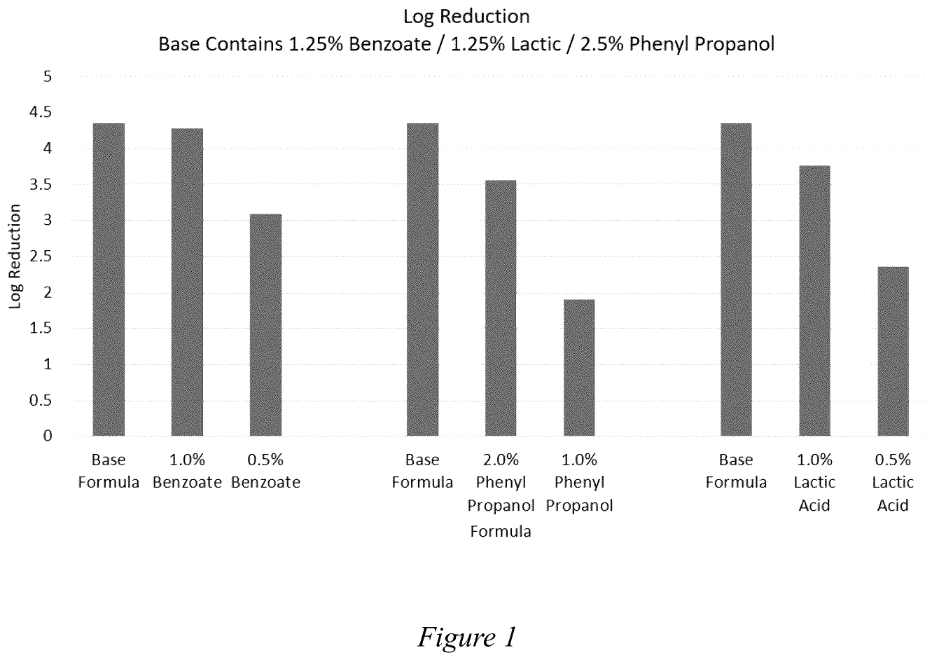

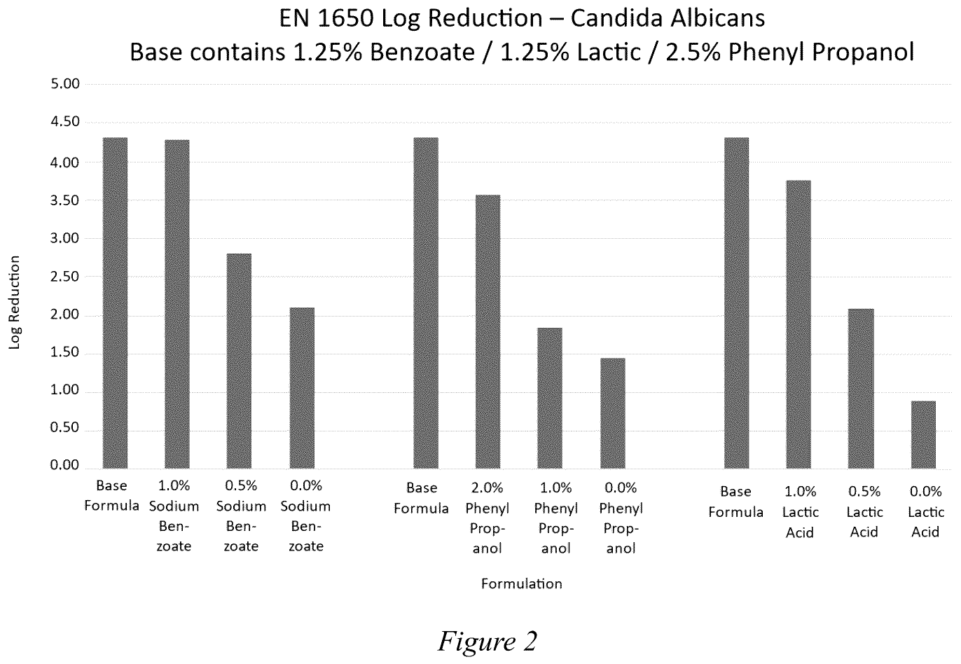

The antimicrobial efficacy of example formulations of the present disclosure (i.e., formulations comprising a preservative, propanol microbial synergist, and organic acid) were compared to formulations comprising the preservative, microbial synergist, or organic acid individually. In particular, the formulations of Table 9 were compared to compositions comprising 1.0% and 0.5% preservative, 2.0% and 1.0% microbial synergist, and 1.0% and 0.5% organic acid. The same test was repeated with the example formulations being compared to compositions free of each of the preservative, microbial synergist, and organic acid. The results are shown in Table 9, FIG. 1, and FIG. 2.

TABLE 9

| | Formulation (wt. %) | | | | | | | | | |
|---|---|---|---|---|---|---|---|---|---|---|
| | LES | LES | LES | LES | LES | LES | LES | LES | LES | LES |
| Component | 16Y | 17A | 17B | 17C | 17D | 17E | 17F | 17M1 | 17N | 17E-1 |
| Water | 82.50 | 82.50 | 82.50 | 83.00 | 84.00 | 82.75 | 83.25 | 81.00 | 81.25 | 81.52 |
| High molecular weight | 0.25 | 0.25 | 0.25 | 0.25 | 0.25 | 0.25 | 0.25 | 0.25 | 0.25 | 0.25 |
| nonionic thickener | | | | | | | | | | |
| Sulfate anionic | 10.00 | 10.00 | 10.00 | 10.00 | 10.00 | 10.00 | 10.00 | 10.00 | 10.00 | 10.00 |
| surfactant (SLS 30%) | | | | | | | | | | |
| Hydrotrope | 1.00 | 1.00 | 1.00 | 1.00 | 1.00 | 1.00 | 1.00 | 1.50 | 1.50 | 1.00 |
| (SXS 30%) | | | | | | | | | | |
| Solvent (Propylene | 1.00 | 1.00 | 1.00 | 1.00 | 1.00 | 1.00 | 1.00 | 1.00 | 1.00 | 1.00 |
| glycol) | | | | | | | | | | |
| Humectant (Glycerin) | 1.00 | 1.00 | 1.00 | 1.00 | 1.00 | 1.00 | 1.00 | 1.00 | 1.00 | 1.00 |
| Preservative/Stabilizer | 0.50 | 0.50 | 0.50 | 0.50 | 0.50 | 0.50 | 0.50 | 0.50 | 0.50 | 0.50 |
| (Glycol ether, phenol | | | | | | | | | | |
| ether) | | | | | | | | | | |
| Microbial synergist | 2.50 | 2.50 | 2.50 | 2.00 | 1.00 | 2.50 | 2.50 | 1.50 | 2.00 | 2.50 |
| (e.g., phenyl propanol) | | | | | | | | | | |
| Organic acid (e.g., | 1.25 | 1.25 | 1.25 | 1.25 | 1.25 | 1.00 | 0.50 | 2.15 | 1.25 | 0.98 |
| lactic acid) | | | | | | | | | | |
| Preservative | 1.25 | 1.00 | 0.50 | 1.25 | 1.25 | 1.25 | 1.25 | 1.25 | 1.25 | 1.25 |
| (Carboxylic acid salt, | | | | | | | | | | |
| e.g., sodium benzoate) | | | | | | | | | | |
| Total | 100.00 | 100.00 | 100.00 | 100.00 | 100.00 | 100.00 | 100.00 | 100.15 | 100.00 | 100.00 |
| pH | 3.96 | 3.83 | 3.36 | 4.06 | 4.10 | 4.26 | 4.82 | 3.52 | 4.05 | 4.26 |
| Log Reduction | 4.35 | 4.28 | 3.09 | 3.56 | 1.90 | 3.76 | 2.36 | 3.60 | 3.52 | 3.42 |

As shown in Table 9, FIG. 1, and FIG. 2, the formulations of the instant application demonstrate an overall substantially improved antimicrobial efficacy compared to any one of the preservative, organic acid, or microbial synergist alone. These results demonstrate a synergistic interaction between the preservative, organic acid, and microbial synergist leading to unexpected and superior antimicrobial efficacy. Beneficially, each of the preservative, organic acid, and microbial synergist may be present in relatively low concentrations of actives while still providing synergistic antimicrobial efficacy.

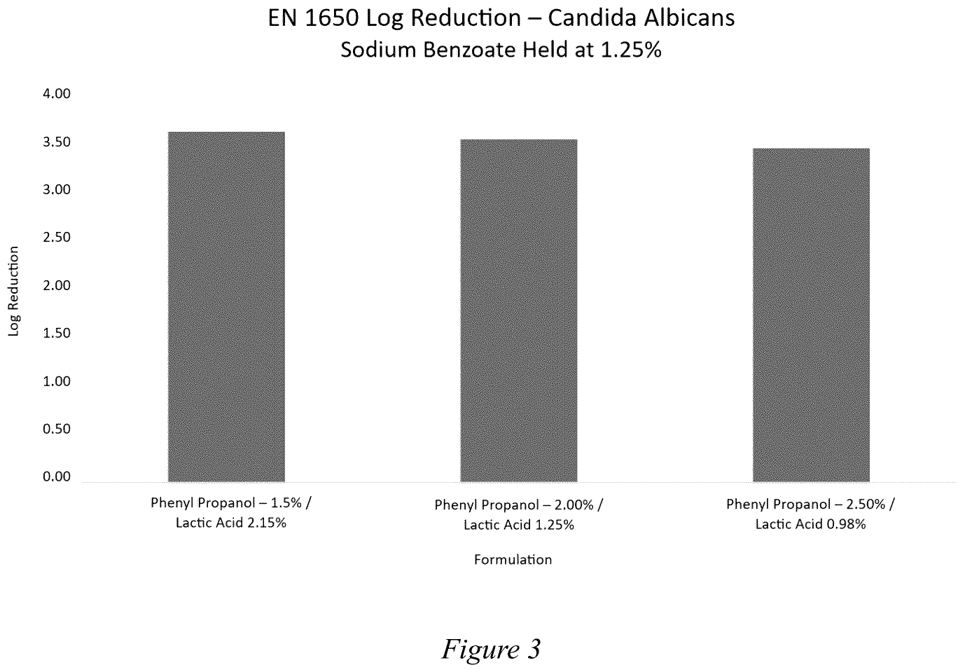

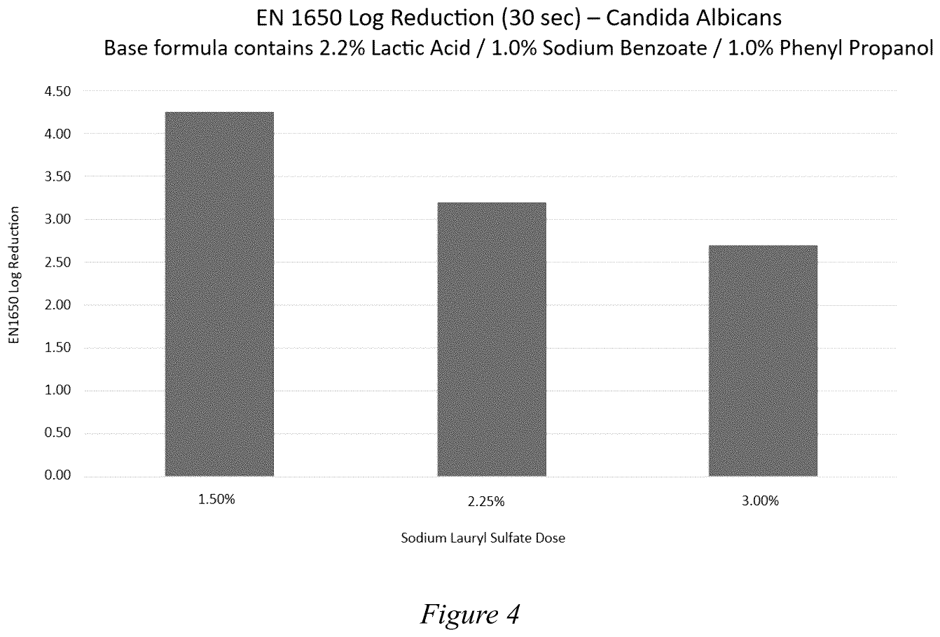

Next, the concentrations of each of the preservative, organic acid, microbial synergist, and anionic surfactant were modified to demonstrate antimicrobial efficacy over a range of concentrations of actives. The concentrations evaluated and the results are shown in FIG. 3 and FIG. 4. As shown in FIG. 3, if the concentrations of the preservative, organic acid, and microbial synergist are adjusted, good antimicrobial efficacy is maintained. As shown in FIG. 4, the concentration of anionic surfactant(s) is preferably not substantially greater than the concentration of the organic acid, preservative, and microbial synergist. Surfactants are preferably included in the formulation to facilitate cleaning, foaming, and solubilization of hydrophobic components into solution.

### Example 5

In order to demonstrate the antibacterial efficacy of the compositions, example compositions were prepared according to Table 10 and were tested to determine their effectiveness against one or more of Staphylococcus aureus, Enterococcus hirae, Escherichia coli, Pseudomonas aeruginosa, and Candida albicans. The compositions were subject to either a 30 or 60 second kill study of the challenge bacteria and yeast. The suspension tests carried out in this example are based on the European protocols EN13624 and EN13727 to determine the antimicrobial performance of the tested compositions against yeast and bacteria respectively. For EN13727 suspension test 1 mL dirty medical Bovine serum albumin (BSA) (soil comprised of 3 g BSA and 3 mL of sheep blood per 1000 mL sterile distilled water) is added to 1 mL test suspension. The two are allowed to interact for 2 min before adding 8 mL of test product, diluted to 50% with 375 ppm hard water. The test temperature was 20° C.

After 30 seconds, 1 mL of the test suspension was added to 9 mL of neutralizer preventing further action of the product. Plating out the neutralized mixture allows enumeration of any remaining viable cells, which can be compared to the initial test suspension for log reduction to be determined. Passing criteria for EN13727 requires a minimum of a 3-log reduction within 60 seconds in order for a composition to be regarded as bactericidal. The same protocol was applied for EN13624 except that it started with a test suspension starting at 10⁻⁶ cfu/mL and a 2 log reduction within 60 seconds is required to pass in order for a composition to be regarded as yeasticidal.

TABLE 10

| | Concentration |
|---|---|
| Component | (wt. %) |
| Water | 75-85 |
| Thickener (e.g., hydroxypropyl guar) | 0.1-0.5 |
| Preservative (e.g., sodium benzoate) | 1-1.5 |
| Sulfate anionic surfactant (e.g., SLS) | 5-15 |
| Hydrotrope (e.g., SXS 40%) | 0.1-1.5 |
| Solvent (e.g., propylene glycol) | 0.5-1.5 |
| Humectant (e.g., glycerin) | 0.5-1.5 |
| Phenolic Compound (e.g., phenoxyethanol) | 0.1-1 |
| Microbial synergist (e.g., phenyl propanol) | 2-3 |
| Organic acid (e.g., lactic acid (80%)) | 0.5-1.5 |

The total number of microorganisms before and after the test protocol was recorded and the log reduction was calculated. The results are shown in Table 11 below.

TABLE 11

| | Test Conditions | | log Reduction in Test | | | | Required | | |
|---|---|---|---|---|---|---|---|---|---|
| European | | Contact | Concentration | | | | log | Pass | Pass |
| Norm | [° C.] | time | 0.1% | 10% | 25% | 50% | reduction | Time | Concentration |
| EN 13727 | 20° C. | 15 | nt | 5.01 | ≥5.50 | ≥5.50 | 3 | 15 s | 25% |
| | | 30 | nt | ≥5.50 | ≥5.50 | ≥5.50 | | | |
| | | 60 | nt | ≥5.50 | ≥5.50 | ≥5.50 | | | |
| | | 15 | nt | 3.91 | 4.92 | ≥5.54 | | | |
| | | 30 | nt | ≥5.54 | ≥5.54 | ≥5.54 | | | |
| | | 60 | nt | ≥5.54 | ≥5.54 | ≥5.54 | | | |
| | | 15 | nt | ≤1.85 | 3.94 | 4.66 | | | |
| | | 30 | nt | 2.13 | ≥5.22 | ≥5.22 | | | |
| | | 60 | nt | 3.19 | ≥5.22 | ≥5.22 | | | |
| | | 15 | nt | 3.33 | 4.90 | ≥5.38 | | | |
| | | 30 | nt | 3.89 | ≥5.38 | ≥5.38 | | | |
| | | 60 | nt | ≥5.38 | ≥5.38 | ≥5.38 | | | |
| EN 13624 | 20° C. | 15 | nt | ≤1.00 | ≤1.00 | 1.85 | 2 | 30 s | 50% |
| | | 30 | nt | ≤1.00 | ≤1.00 | 3.27 | | | |
| | | 60 | nt | ≤1.00 | ≤1.00 | 4.37 | | | |

### Example 6

A further evaluation of the virucidal efficacy of the compositions of the disclosure was carried out with Modified Vaccinia Virus, strain Ankara (MVA), an enveloped DNA virus, to test the hygienic hand washing disinfection and hand washing capabilities, using the test protocol of standard EN 14476. In particular, 1 mL of bovine albumin (3.0 g/L, dirty conditions) was pipetted into a container with 1 mL of the virus test suspension. 8 mL of the composition of Table 10 was added to the container. The test condition temperature was 20° C. After an exposure time of 15 seconds, 30 seconds or 60 seconds, partial volumes were removed and immediately transferred to an ice-cold maintenance medium to suppress the virucidal activity. The virus titre was then calculated and the log reduction of the MVA was then determined consistent with the standards of EN 14476. The results are shown in Table 12.

TABLE 12

| | | | log Reduction in Test | | | | Required | | |
|---|---|---|---|---|---|---|---|---|---|
| European | | Contact | Concentration | | | | log | Pass | Pass |
| Norm | Organism | time | 0.1% | 10% | 25% | 50% | Reduction | Time | Concentration |
| EN 14476 | Modified | 15 | 0.19 | >3.88 | ≥4.32 | ≥5.10 | 2 | 30 s | 25% |
| | Vaccinia | 30 | 0.25 | ≥4.32 | ≥4.32 | ≥5.10 | | | |
| | Virus, | 60 | 0.19 | ≥4.32 | ≥4.32 | ≥5.10 | | | |
| | strain Ankara | | | | | | | | |
| | (MVA) | | | | | | | | |

### Example 7

An assessment of the antibacterial efficacy of the compositions as a hygienic hand wash was conducted according to the protocol EN 1499. According to this protocol, the hands of volunteers are artificially contaminated with test organisms, in this case Escherichia coli. The number of test organisms released from volunteers' fingertips into sampling fluids is assessed before and after the hygienic handwash, in order to calculate the relative change in microbial concentration. In particular, volunteers' hands are prepared by washing for 1 minute with 5 mL of diluted soap without the use of a brush. After rinsing with tap water, the hands are thoroughly dried and the fingertips are rubbed for 1 minute on the base of a Petri dish containing 10 mL of TSB as sampling fluid in order to assess the organisms present before treatment of the hands.

The contamination fluid as described in EN 1499 is poured into a container and both hands are immersed up to the mid-metacarpals for 5 seconds. Excess fluid is allowed to drain off the hands and the hands are air dried for 3 minutes. The hands are then contacted with either 1.5 mL of the compositions of Table 10 or a control composition for 30 seconds. Immediately after treatment, the same sampling procedure was used to assess the organisms present after treatment of the hands. The log reduction in Eschericia coli after treatment was then calculated. The results are shown in Table 13 below.

TABLE 13

| | | | | log Reduction | | | | |
|---|---|---|---|---|---|---|---|---|
| | | | | in Test | | | | |
| | | | | Concentration | | required | | |
| European | Test conditions | | Contact | | Test | log | pass | pass |
| Norm | Vol. | Organism | time [s] | Control | Form. | reduction | time | concentration |
| EN 1499 | 1.5 ml | Echerichia | 30 | 2.93 | 3.40 | mean | 30 s | 100% |
| | | coli | | | | reduction | | |
| | | | | | | significantly | | |
| | | | | | | larger than | | |
| | | | | | | reference | | |

### Example 8

A further evaluation of the virucidal efficacy of the compositions of the disclosure was carried out using the quantitative suspension test protocol of standard EN 14476, similar to Example 6 and using the formulation of Table 10. In particular, 1 mL of bovine albumin (3.0 g/L, dirty conditions) was pipetted into a container with 1 mL of the virus test suspension. 8 mL of the composition of Table 10 was added to the container. The test condition temperature was 20° C. After an exposure time of 15 seconds, 30 seconds or 60 seconds, partial volumes were removed and immediately transferred to an ice-cold maintenance medium to suppress the virucidal activity. The virus titre was then calculated and the log reduction of the MVA was then determined consistent with the standards of EN 14476.

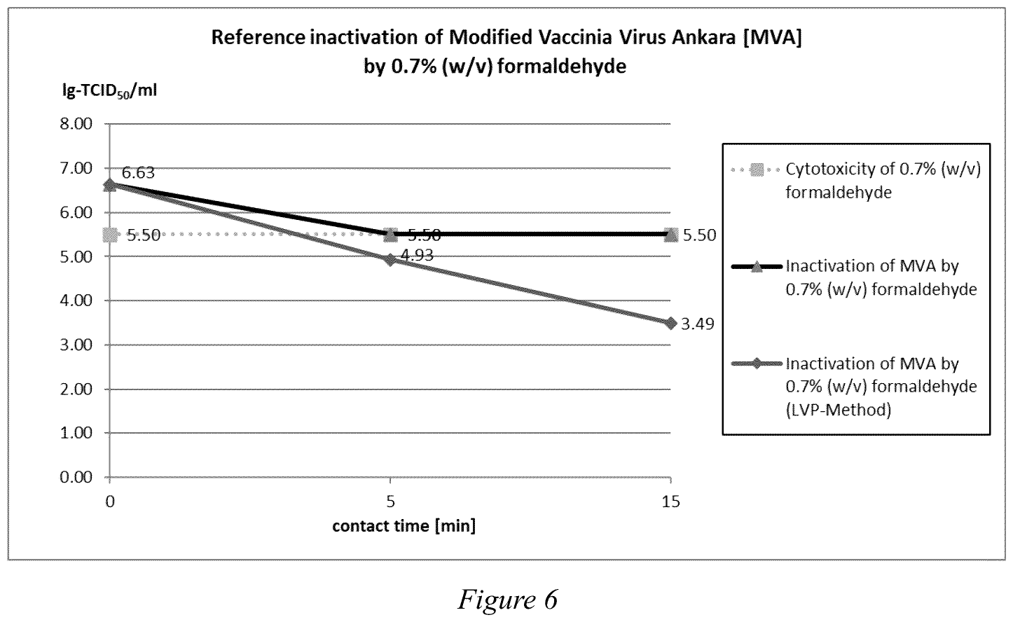

Summaries of the results of the quantitative suspension test according EN 14476 with FC923975 (the formula of Table 10), and Modified Vaccinia virus Ankara and the results of the controls are shown in Tables 14A-17C and FIGS. 1-6.

TABLE 14A
Summary of the results with Modified Vaccinia virus Ankara.

| | | | | | | ≥4 lg |
|---|---|---|---|---|---|---|
| | | lg-TCID₅₀/ml after + | | | | reduction |
| Test sample | | 95.0% confidence interval | | | | after |
| concentration | lg-CD₅₀ | 0 s | 15 s | 30 s | 60 s | seconds |
| 50% | ≤3.50 | n.a. | ≤3.50 ± 0.00 | ≤3.50 ± 0.00 | ≤3.50 ± 0.00 | — |
| 25% | ≤3.50 | n.a. | ≤3.50 ± 0.00 | ≤3.50 ± 0.00 | ≤3.50 ± 0.00 | — |
| 10% | ≤2.50 | n.a. | ≤2.50 ± 0.00 | ≤2.50 ± 0.00 | ≤2.50 ± 0.00 | 15 |
| Virus | n.a. | 7.00 ± 0.38 | n.d. | n.d. | 6.63 ± 0.26 | n.a. |
| control | | | | | | |

TABLE 14B
Summary of the results with Modified Vaccinia virus Ankara

| | | | | | ≥4 lg |
|---|---|---|---|---|---|
| | | lg-TCID₅₀/ml after ± | | | reduction |
| Test sample | | 95.0% confidence interval | | | after |
| concentration | lg-CD₅₀ | 0 s | 15 s | 30 s | seconds |
| 50% | ≤3.50 | n.a. | ≤3.50 ± | ≤3.50 ± | — |
| | | | 0.00 | 0.00 | |
| 50% | n.a. | n.a. | n.d. | ≤1.64 | 30 |
| (LVP-Method) | | | | | |
| Virus control | n.a. | 6.63 ± | n.d. | 6.75 ± | n.a. |
| | | 0.26 | | 0.32 | |

TABLE 14C
Summary of the results with Modified Vaccinia virus Ankara

| | | lg-TCID₅₀/ml after ± | | | | ≥4 lg |
|---|---|---|---|---|---|---|
| Test sample | | 95.0% confidence interval | | | | reduction |
| concentration | lg-CD₅₀ | 0 s | 15 s | 30 s | 60 s | after seconds |
| 5% | ≤2.50 | n.a. | 5.13 ± | 4.88 ± | 3.25 ± | − |
| | | | 0.46 | 0.36 | 0.32 | |
| 1% | ≤1.50 | n.a. | 6.38 ± | 6.00 ± | 6.25 ± | − |
| | | | 0.26 | 0.38 | 0.32 | |
| Virus | n.a. | 6.38 ± | n.d. | n.d. | 6.63 ± | n.a. |
| control | | 0.26 | | | 0.26 | |

TABLE 15A
Summary of the results with Modified Vaccinia
virus Ankara showing the reduction factors

| | | | Reduction | | |
|---|---|---|---|---|---|
| Test sample | | Virus control | factor [lg] ± | | |
| concen- | | [lg- | 95.0% confidence interval | | |
| tration | lg-CD₅₀ | TCID₅₀/ml] | 15 s | 30 s | 60 s |
| 50% | ≤3.50 | 7.00 ± | ≥3.50 ± | ≥3.50 ± | ≥3.50 ± |
| | | 0.38 | 0.38 | 0.38 | 0.38 |
| 25% | ≤3.50 | | ≥3.50 ± | ≥3.50 ± | ≥3.50 ± |
| | | | 0.38 | 0.38 | 0.38 |
| 10% | ≤2.50 | | ≥4.50 ± | ≥4.50 ± | ≥4.50 ± |
| | | | 0.38 | 0.38 | 0.38 |

TABLE 15B
Summary of the results with Modified Vaccinia
virus Ankara showing the reduction factors

| | | | Reduction | |
|---|---|---|---|---|
| | | Virus control | factor [lg] ± | |
| Test sample | | [lg- | 95.0% confidence interval | |
| concentration | lg-CD₅₀ | TCID₅₀/ml] | 15 s | 30 s |
| 50% | ≤3.50 | 6.63 ± 0.26 | ≥3.13 ± 0.26 | ≥3.13 ± 0.26 |
| 50% | n.a. | | n.d. | ≥4.99 ± 0.26 |
| (LVP-Method) | | | | |

TABLE 15C
Summary of the results with Modified Vaccinia
virus Ankara showing the reduction factors

| | | | Reduction | | |
|---|---|---|---|---|---|
| | | Virus control | factor [lg] ± | | |
| Test sample | lg- | [lg- | 95.0% confidence interval | | |
| concentration | CD₅₀ | TCID₅₀/ml] | 15 s | 30 s | 60 s |
| 5% | ≤2.50 | 6.38 ± | 1.25 ± | 1.50 ± | 3.13 ± |
| | | 0.26 | 0.53 | 0.44 | 0.41 |
| 1% | ≤1.50 | | 0.00 ± | 0.38 ± | 0.13 ± |
| | | | 0.37 | 0.46 | 0.41 |

TABLE 16A
Controls of Modified Vaccinia virus Ankara

| | | lg-TCID₅₀/ml after ± | | | | |
|---|---|---|---|---|---|---|
| | | 95.0% confidence interval | | | | |
| Control | lg-CD₅₀ | w/o | 0 s | 15 s | 30 s | 60 s |
| Virus test | n.a. | n.a. | 7.50 ± | n.a. | n.a. | n.a. |
| suspension | | | 0.36 | | | |
| Virus control | n.a. | n.a. | 7.00 ± | n.d. | n.d. | 6.63 ± |
| | | | 0.38 | | | 0.26 |
| Inactivation | ≤3.50 | 6.88 ± | n.a. | n.a. | n.a. | n.a. |
| control 50% | | 0.36 | | | | |
| Virus control | n.a. | 7.25 ± | n.a. | n.a. | n.a. | n.a. |
| inactivation | | 0.32 | | | | |
| Cell susceptibility | n.a. | 6.63 ± | n.a. | n.a. | n.a. | n.a. |
| (PBS) | | 0.26 | | | | |
| Cell susceptibility | ≤1.50 | 6.75 ± | n.a. | n.a. | n.a. | n.a. |
| (0.05%) | | 0.32 | | | | |

TABLE 16B
Controls of Modified Vaccinia virus Ankara

| | | lg-TCID₅₀/ml after ± | | | |
|---|---|---|---|---|---|
| | lg- | 95.0% confidence interval | | | |
| Control | CD₅₀ | w/o | 0 s | 15 s | 30 s |
| Virus test suspension | n.a. | n.a. | 7.88 ± 0.36 | n.a. | n.a. |
| Virus control | n.a. | n.a. | 6.63 ± 0.26 | n.a. | 6.75 ± 0.32 |

TABLE 16C
Controls of Modified Vaccinia virus Ankara

| | | lg-TCID₅₀/ml after ± | | | | |
|---|---|---|---|---|---|---|
| | | 95.0% confidence interval | | | | |
| Control | lg-CD₅₀ | w/o | 0 s | 15 s | 30 s | 60 s |
| Virus test | n.a. | n.a. | 7.50 ± | n.a. | n.a. | n.a. |
| suspension | | | 0.36 | | | |
| Virus control | n.a. | n.a. | 6.38 ± | n.a. | n.a. | 6.63 ± |
| | | | 0.26 | | | 0.26 |

TABLE 17A
Reference inactivation of Modified Vaccinia Virus Ankara

| | | | lg-TCID₅₀/ml | | | Reduction factor [lg] ± | |
|---|---|---|---|---|---|---|---|
| | | | after ± 95.0% | | | 95.0% confidence | |
| Reference | Interfering | | confidence interval | | | interval | |
| control | substance | lg-CD₅₀ | 0 min | 5 min | 15 min | 5 min | 15 min |
| 0.7% (w/v) | PBS | ≤5.50 | n.a. | ≤5.50 ± | ≤5.50 ± | ≥1.13 ± | ≥1.13 ± |
| formaldehyde | | | | 0.00 | 0.00 | 0.26 | 0.26 |
| solution | | | | | | | |
| 0.7% (w/v) | | n.a. | n.a. | 4.93 | 3.49 | 1.70 ± | 3.14 ± |
| formaldehyde | | | | | | 0.26 | 0.26 |
| solution | | | | | | | |
| (LVP-Method) | | | | | | | |
| Virus | | n.a. | 6.63 ± | n.d. | 6.50 ± | n.a. | n.a. |
| control | | | 0.26 | | 0.00 | | |

TABLE 17B
Reference Inactivation of Modified Vaccinia virus Ankara

| | | | lg-TCID₅₀/ml | | | Reduction factor [lg] ± | |
|---|---|---|---|---|---|---|---|
| | | | after ± 95.0% | | | 95.0% confidence | |
| Reference | Interfering | | confidence interval | | | interval | |
| control | substance | lg-CD₅₀ | 0 min | 5 min | 15 min | 5 min | 15 min |
| 0.7% (w/v) | PBS | ≤5.50 | n.a. | ≤5.50 ± | ≤5.50 ± | ≥1.125 ± | ≥1.25 ± |
| formaldehyde | | | | 0.00 | 0.00 | 0.32 | 0.32 |
| solution | | | | | | | |
| 0.7% (w/v) | | n.a. | n.a. | 4.88 | 3.79 | 1.87 ± | 2.96 ± |
| formaldehyde | | | | | | 0.32 | 0.32 |
| solution | | | | | | | |
| (LVP-Method) | | | | | | | |
| Virus | | n.a. | 6.75 ± | n.d. | 6.63 ± | n.a. | n.a. |
| control | | | 0.32 | | 0.26 | | |

TABLE 17C
Reference Inactivation of Modified Vaccinia virus Ankara

| | | | lg-TCID₅₀/ml | | | Reduction factor [lg] ± | |
|---|---|---|---|---|---|---|---|
| | | | after ± 95.0% | | | 95.0% confidence | |
| Reference | Interfering | | confidence interval | | | interval | |
| control | substance | lg-CD₅₀ | 0 min | 5 min | 15 min | 5 min | 15 min |
| 0.7% (w/v) | PBS | ≤4.50 | n.a. | ≤4.50 ± | ≤4.50 ± | ≥1.88 ± | ≥1.88 ± |
| formaldehyde | | | | 0.00 | 0.00 | 0.26 | 0.26 |
| solution | | | | | | | |
| 0.7% (w/v) | | n.a. | n.a. | 4.85 | 3.65 | 1.53 ± | 2.73 ± |
| formaldehyde | | | | | | 0.26 | 0.26 |
| solution | | | | | | | |
| (LVP-Method) | | | | | | | |
| Virus | | n.a. | 6.38 ± | n.d. | 6.50 ± | n.a. | n.a. |
| control | | | 0.26 | | 0.00 | | |

Consistent with the requirements of EN 14476 (2013+A2:2019), the required ≥2 log unit titre reduction of Modified Vaccinia virus Ankara could be achieved with the products of the disclosure under dirty conditions at 20° C. in 30 seconds when diluted at 50% (v/v) in 15, 30 and 60 seconds when diluted at 10% (v/v).

### Example 9

Consistent with Example 5, the compositions of the disclosure (as shown in the formulation of Table 10) were subject to either a 30 or 60 second suspension test kill study of the challenge bacteria and yeast. The suspension tests carried was based on the European EN13624 to determine the antimicrobial performance of the tested compositions against yeast (Candida albicans). In this test, 1 mL dirty medical Bovine serum albumin (BSA) (soil comprised of 3 g BSA and 3 mL of sheep blood per 1000 mL sterile distilled water) is added to 1 mL test suspension and 9 mL of neutralizer. Plating out the neutralized mixture allows enumeration of any remaining viable cells, which can be compared to the initial test suspension for log reduction to be determined. Passing criteria required a test suspension starting at 10⁻⁶ cfu/mL and a 2 log reduction within 60 seconds in order for a composition to be regarded as yeasticidal. The test temperature was 20° C. The results are shown in Table 18 below.

TABLE 18

| | Test Organism | | Test Procedure (Nₐ) at Test | | | |
|---|---|---|---|---|---|---|
| Contact | Suspension | | Sample Concentration of: | | | |
| time | (N and N₀) | | 50% | 25% | 10% | |
| pH | | | 3.99 | 3.81 | 3.79 | |
| | 10⁻⁵: 283 266 | V_{C}10⁻²: | 141 146 | >330 >330 | >330 >330 | |
| | 10⁻⁶: 28 26 | | | | | |
| 15 s | N: 2.74E±07 | Nₐ: | 1.44E±05 | 3.30E±05 | 3.30E±05 | n.d. |
| | lgN: 7.44 | lgNₐ: | 5.16 | 5.52 | 5.52 | |
| | lgN₀: 6.44 | lgR: | 1.28 | 0.92 | 0.92 | |
| Test valid | yes | lgR ≥ 2 | no | no | no | |
| | 10⁻⁵: 283 266 | V_{C}10⁻²: | 1 3 | >330 >330 | >330 >330 | |
| | 10⁻⁶: 28 26 | | | | | |
| 30 s | N: 2.74E±07 | Nₐ: | <1.40E±04 | 3.30E±05 | 3.30E±05 | n.d. |
| | lgN: 7.44 | lgNₐ: | <4.15 | 5.52 | 5.52 | |
| | lgN₀: 6.44 | lgR: | >2.29 | 0.92 | 0.92 | |
| Test valid | yes | lgR ≥ 2 | yes | no | no | |
| | 10⁻⁵: 283 266 | V_{C}10⁻²: | 0 0 | >330 >330 | >330 >330 | |
| | 10⁻⁶: 28 26 | | | | | |
| 60 s | N: 2.74E±07 | Nₐ: | <1.40E±04 | 3.30E±05 | 3.30E±05 | n.d. |
| | lgN: 7.44 | lgNₐ: | <4.15 | 5.52 | 5.52 | |
| | lgN₀: 6.44 | lgR: | >2.29 | 0.92 | 0.92 | |
| Test valid | yes | lgR ≥ 2 | yes | no | no | |

As shown in Table 18 and consistent with the requirements of EN 13624 (2022) the products disclosed herein shows a yeasticidal activity (≥2 log reduction for hand wash) under dirty conditions at 20° C. in 30 and 60 seconds when diluted at 50% (v/v) against the test organism Candida albicans.

### Example 10

To further evaluate antibacterial efficacy, the compositions of Table 10 were evaluated as part of a hand wash test consistent with EN13727. The compositions were evaluated for their effectiveness against one or more of Staphylococcus aureus, Enterococcus hirae, Escherichia coli, and Pseudomonas aeruginosa. Concentrations of 50%, 25%, 10%, 5%, and 1% were subject to either a 30 or 60 second kill study of the challenge bacteria.b1 mL dirty medical Bovine serum albumin (BSA) (soil comprised of 3 g BSA and 3 mL of sheep blood per 1000 mL sterile distilled water) was added to 1 mL test suspension. The two were allowed to interact for 2 min before adding 8 mL of test product, diluted to 50% with 375 ppm hard water. The test temperature was 20° C.

After 30 seconds, 1 mL of the test suspension was added to 9 mL of neutralizer preventing further action of the product. Plating out the neutralized mixture allows enumeration of any remaining viable cells, which can be compared to the initial test suspension for log reduction to be determined. Passing criteria for EN13727 requires a minimum of a 3-log reduction within 60 seconds in order for a composition to be regarded as bactericidal. The results are shown in Tables 19-24.

TABLE 19

| | Test organism | | Test procedure (Na) at test | | | |
|---|---|---|---|---|---|---|
| Contact | suspension | | sample concentration of | | | |
| time | (N and N₀) | | 50% | 25% | 10% | |
| pH-values | | | 3.99 | 3.81 | 3.79 | |
| 15 s | 10⁻⁶: >330 >330 | V_{C}10⁻²: | 0 0 | 0 0 | 0 0 | n.d. |
| | 10⁻⁷: 33 36 | Nₐ: | <1.40±04 | <1.40±04 | <1.40±04 | |
| | N: 3.45E±08 | lgNₐ: | <4.15 | <4.15 | <4.15 | |
| | lgN: 8.54 | lgR: | >3.39 | >3.39 | >3.39 | |
| | lgN₀: 7.54 | | | | | |
| Test valid | yes | lgR ≥ 3 | yes | yes | yes | |
| 30 s | 10⁻⁶: >330 >330 | V_{C}10⁻²: | 0 0 | 0 0 | 0 0 | n.d. |
| | 10⁻⁷: 33 36 | Nₐ: | <1.40±04 | <1.40±04 | <1.40±04 | |
| | N: 3.45E±08 | lgNₐ: | <4.15 | <4.15 | <4.15 | |
| | lgN: 8.54 | lgR: | >3.39 | >3.39 | >3.39 | |
| | lgN₀: 7.54 | | | | | |
| Test valid | yes | lgR ≥ 3 | yes | yes | yes | |
| 60 s | 10⁻⁶: >330 >330 | V_{C}10⁻²: | 0 0 | 0 0 | 0 0 | n.d. |
| | 10⁻⁷: 33 36 | Nₐ: | <1.40±04 | <1.40±04 | <1.40±04 | |
| | N: 3.45E±08 | lgNₐ: | <4.15 | <4.15 | <4.15 | |
| | lgN: 8.54 | lgR: | >3.39 | >3.39 | >3.39 | |
| | lgN₀: 7.54 | | | | | |
| Test valid | yes | lgR ≥ 3 | yes | yes | yes | |

TABLE 20

| | Test organism | | Test procedure (Na) at test | | | |
|---|---|---|---|---|---|---|
| Contact | suspension | | sample concentration of | | | |
| time | (N and N₀) | | 5% | 1% | | |
| pH-values | | | 3.94 | 4.26 | | |
| 15 s | 10⁻⁶: 176 173 | Vc10⁻²: | >330 >330 | >330 >330 | n.d. | n.d. |
| | 10⁻⁷: 22 23 | Nₐ: | >3.30E±05 | >3.30E±05 | | |
| | N: 1.79E±08 | lgNₐ: | >5.52 | >5.52 | | |
| | lgN: 8.25 | lgR: | <1.73 | <1.73 | | |
| | lgN₀: 7.25 | | | | | |
| Test valid | yes | lgR ≥ 3 | no | no | | |
| 30 s | 10⁻⁶: 176 173 | Vc10⁻²: | >330 >330 | >330 >330 | n.d. | n.d. |
| | 10⁻⁷: 22 23 | Nₐ: | >3.30E±05 | >3.30E±05 | | |
| | N: 1.79E±08 | lgNₐ: | >5.52 | >5.52 | | |
| | lgN: 8.25 | lgR: | <1.73 | <1.73 | | |
| | lgN₀: 7.25 | | | | | |
| Test valid | yes | lgR ≥3 | no | no | | |
| 60 s | 10⁻⁶: 176 173 | Vc10⁻²: | >330 >330 | >330 >330 | n.d. | n.d. |
| | 10⁻⁷: 22 23 | Nₐ: | >3.30E±05 | >3.30E±05 | | |
| | N: 1.79E±08 | lgNₐ: | >5.52 | >5.52 | | |
| | lgN: 8.25 | lgR: | <1.73 | <1.73 | | |
| | lgN₀: 7.25 | | | | | |
| Test valid | yes | lgR ≥ 3 | no | no | | |

TABLE 21

| | Test organism | | Test procedure (Na) at test | | | |
|---|---|---|---|---|---|---|
| Contact | suspension | | sample concentration of | | | |
| time | (N and N₀) | | 50% | 25% | 10% | |
| pH-values | | | 3.99 | 3.81 | 3.79 | |
| 15 s | 10⁻⁶: 187 206 | V_{C}10⁻²: | 0 0 | 0 0 | 0 0 | n.d. |
| | 10⁻⁷: 21 22 | Nₐ: | <1.40E±04 | <1.40E±04 | <1.40E±04 | |
| | N: 1.98E±08 | lgNₐ: | <4.15 | <4.15 | <4.15 | |
| | lgN: 8.30 | lgR: | >3.15 | >3.15 | >3.15 | |
| | lgN₀: 7.30 | | | | | |
| Test valid | yes | lgR ≥ 3 | yes | yes | yes | |
| 30 s | 10⁻⁶: 187 206 | V_{C}10⁻²: | 0 0 | 0 0 | 0 0 | n.d. |
| | 10⁻⁷: 21 22 | Nₐ: | <1.40E±04 | <1.40E±04 | <1.40E±04 | |
| | N: 1.98E±08 | lgNₐ: | <4.15 | <4.15 | <4.15 | |
| | lgN: 8.30 | lgR: | >3.15 | >3.15 | >3.15 | |
| | lgN₀: 7.30 | | | | | |
| Test valid | yes | lgR ≥ 3 | yes | yes | yes | |
| 60 s | 10⁻⁶: 187 206 | V_{C}10⁻²: | 0 0 | 0 0 | 0 0 | n.d. |
| | 10⁻⁷: 21 22 | Nₐ: | <1.40E±04 | <1.40E±04 | <1.40E±04 | |
| | N: 1.98E±08 | lgNₐ: | <4.15 | <4.15 | <4.15 | |
| | lgN: 8.30 | lgR: | >3.15 | >3.15 | >3.15 | |
| | lgN₀: 7.30 | | | | | |
| Test valid | yes | lgR ≥ 3 | yes | yes | yes | |

TABLE 22

| | Test organism | | Test procedure (Na) at test | | | |
|---|---|---|---|---|---|---|
| Contact | suspension | | sample concentration of | | | |
| time | (N and N₀) | | 50% | 25% | 10% | |
| pH-values | | | 3.99 | 3.81 | 3.79 | |
| 15 s | 10⁻⁶: 184 180 | V_{C}10⁻²: | 0 0 | 0 0 | 0 0 | n.d. |
| | 10⁻⁷: 22 23 | Nₐ: | <1.40E±04 | <1.40E±04 | <1.40E±04 | |
| | N: 1.86E±08 | lgNₐ: | <4.15 | <4.15 | <4.15 | |
| | lgN: 8.27 | lgR: | >3.12 | >3.12 | >3.12 | |
| | lgN₀: 7.27 | | | | | |
| Test valid | yes | lgR ≥ 3 | yes | yes | yes | |
| 30 s | 10⁻⁶: 184 180 | V_{C}10⁻²: | 0 0 | 0 0 | 0 0 | n.d. |
| | 10⁻⁷: 22 23 | Nₐ: | <1.40E±04 | <1.40E±04 | <1.40E±04 | |
| | N: 1.86E±08 | lgNₐ: | <4.15 | <4.15 | <4.15 | |
| | lgN: 8.27 | lgR: | >3.12 | >3.12 | >3.12 | |
| | lgN₀: 7.27 | | | | | |
| Test valid | yes | lgR ≥ 3 | yes | yes | yes | |
| 60 s | 10⁻⁶: 184 180 | V_{C}10⁻²: | 0 0 | 0 0 | 0 0 | n.d. |
| | 10⁻⁷: 22 23 | Nₐ: | <1.40E±04 | <1.40E±04 | <1.40E±04 | |
| | N: 1.86E±08 | lgNₐ: | <4.15 | <4.15 | <4.15 | |
| | lgN: 8.27 | lgR: | >3.12 | >3.12 | >3.12 | |
| | lgN₀: 7.27 | | | | | |
| Test valid | yes | lgR ≥ 3 | yes | yes | yes | |

TABLE 23

| | Test organism | | Test procedure (Na) at test | | | |
|---|---|---|---|---|---|---|
| Contact | suspension | | sample concentration of | | | |
| time | (N and N₀) | | 50% | 25% | 10% | |
| pH-values | | | 3.99 | 3.81 | 3.79 | |
| 15 s | 10⁻⁶: 152 159 | V_{C}10⁻²: | 0 0 | 0 0 | 0 0 | |
| | 10⁻⁷: 18 15 | Nₐ: | <1.40E±04 | <1.40E±04 | <1.40E±04 | |
| | N: 1.56E±08 | lgNₐ: | <4.15 | <4.15 | <4.15 | |
| | lgN: 8.19 | lgR: | >3.04 | >3.04 | >3.04 | n.d. |
| | lgN₀: 7.19 | | | | | |
| Test valid | yes | lgR ≥ 3 | yes | yes | yes | |
| 30 s | 10⁻⁶: 152 159 | V_{C}10⁻²: | 0 0 | 0 0 | 0 0 | |
| | 10⁻⁷: 18 15 | Nₐ: | <1.40E±04 | <1.40E±04 | <1.40E±04 | |
| | N: 1.56E±08 | lgNₐ: | <4.15 | <4.15 | <4.15 | n.d. |
| | lgN: 8.19 | lgR: | >3.04 | >3.04 | >3.04 | |
| | lgN₀: 7.19 | | | | | |
| Test valid | yes | lgR ≥ 3 | yes | yes | yes | |
| 60 s | 10⁻⁶: 152 159 | V_{C}10⁻²: | 0 0 | 0 0 | 0 0 | |
| | 10⁻⁷: 18 15 | Nₐ: | <1.40E±04 | <1.40E±04 | <1.40E±04 | |
| | N: 1.56E±08 | lgNₐ: | <4.15 | <4.15 | <4.15 | n.d. |
| | lgN: 8.19 | lgR: | >3.04 | >3.04 | >3.04 | |
| | lgN₀: 7.19 | | | | | |
| Test valid | yes | lgR ≥ 3 | yes | yes | yes | |

TABLE 24

| | Test organism | | Test procedure (Na) at test | | | |
|---|---|---|---|---|---|---|
| Contact | suspension | | sample concentration of | | | |
| time | (N and N₀) | | 50% | 25% | 10% | |
| pH-values | | | 3.99 | 3.81 | 3.79 | |
| 15 s | 10⁻⁶: 186 213 | V_{C}10⁻²: | 0 0 | 0 0 | 0 0 | n.d. |
| | 10⁻⁷: 26 27 | Nₐ: | <1.40E±04 | <1.40E±04 | <1.40E±04 | |
| | N: 2.05E±08 | lgNₐ: | <4.15 | <4.15 | <4.15 | |
| | lgN: 8.31 | lgR: | >3.16 | >3.16 | >3.16 | |
| | lgN₀: 7.31 | | | | | |
| Test valid | yes | lgR ≥3 | yes | yes | yes | |
| 30 s | 10⁻⁶: 186 213 | V_{C}10⁻²: | 0 0 | 0 0 | 0 0 | n.d. |
| | 10⁻⁷: 26 27 | Nₐ: | <1.40E±04 | <1.40E±04 | <1.40E±04 | |
| | N: 2.05E±08 | lgNₐ: | <4.15 | <4.15 | <4.15 | |
| | lgN: 8.31 | lgR: | >3.16 | >3.16 | >3.16 | |
| | lgN₀: 7.31 | | | | | |
| Test valid | yes | lgR ≥3 | yes | yes | yes | |
| 60 s | 10⁻⁶: 186 213 | V_{C}10⁻²: | 0 0 | 0 0 | 0 0 | |
| | 10⁻⁷: 26 27 | Nₐ: | <1.40E±04 | <1.40E±04 | <1.40E±04 | |
| | N: 2.05E±08 | lgNₐ: | <4.15 | <4.15 | <4.15 | n.d. |
| | lgN: 8.31 | lgR: | >3.16 | >3.16 | >3.16 | |
| | lgN₀: 7.31 | | | | | |
| Test valid | yes | lgR ≥ 3 | yes | yes | yes | |

Consistent with the standards of EN 13727 (2012+A2:2015), the formulations of the disclosure show a bactericidal activity (≥3 log reduction for hand wash) under dirty conditions at 20° C. in 15, 30 and 60 seconds when diluted at 50%, 25% and 10% (v/v) against the test organisms Staphylococcus aureus, Enterococcus hirae, Escherichia coli, Pseudomonas aeruginosa and Proteus mirabilis.

### Example 11

A further assessment of the antibacterial efficacy of the compositions of Table 10 as a hygienic hand wash was conducted according to the protocol EN 1499 and as outlined in Example 7. The results are shown in Table

TABLE 24
List of Computed Log Values and Log Reductions

| | Sequence: | | | | Handewaschung mit | | |
|---|---|---|---|---|---|---|---|
| | Control | Control Handwash (CP) | | | Prüfprodukt/ | | |
| | Product (CP) | (20% m/v) | | | handwash with product TP | | |
| | vs. Test | Log (Pre- | Log (Post- | | Log (Pre- | Log (Post- | |
| Volunteer | Product (TP) | Wash) | Wash) | Log R | Wash) | Wash) | Log R |
| 1 | CP => TP | 6.88 | 3.97 | 2.91 | 6.98 | 3.38 | 3.60 |
| 2 | CP => TP | 6.71 | 3.29 | 3.42 | 6.42 | 2.73 | 3.69 |
| 3 | CP => TP | 6.39 | 3.94 | 2.45 | 6.82 | 3.28 | 3.54 |
| 4 | CP => TP | 6.55 | 3.17 | 3.38 | 6.65 | 3.11 | 3.54 |
| 5 | CP => TP | 7.03 | 4.13 | 2.90 | 7.04 | 3.63 | 3.41 |
| 6 | CP => TP | 6.57 | 3.18 | 3.39 | 5.91 | 2.77 | 3.14 |
| 7 | CP => TP | 6.83 | 3.68 | 3.15 | 6.78 | 3.41 | 3.37 |
| 8 | CP => TP | 5.85 | 4.12 | 1.73 | 6.40 | 3.15 | 3.25 |
| 9 | TP => CP | 7.08 | 3.84 | 3.24 | 6.66 | 3.62 | 3.04 |
| 10 | TP => CP | 6.72 | 3.81 | 2.91 | 6.26 | 3.45 | 2.81 |
| 11 | TP => CP | 6.87 | 3.83 | 3.04 | 6.56 | 3.39 | 3.17 |
| 12 | TP => CP | 6.40 | 4.45 | 1.95 | 6.91 | 3.31 | 3.60 |
| 13 | TP => CP | 7.01 | 3.34 | 3.67 | 6.96 | 3.27 | 3.69 |
| 14 | TP => CP | 6.81 | 3.97 | 2.84 | 6.78 | 3.06 | 3.72 |
| 15 | TP => CP | 7.01 | 4.09 | 2.92 | 6.96 | 3.52 | 3.44 |
| x̅ | Overall | 6.71 | 3.79 | 2.93 | 6.67 | 3.27 | 3.40 |
| s | | 0.33 | 0.38 | 0.53 | 0.32 | 0.27 | 0.27 |
| NN | | 15 | 15 | 15 | 15 | 15 | 15 |
| x̅ | CP => TP | 6.60 | 3.69 | 2.92 | 6.63 | 3.18 | 3.44 |
| s | | 0.37 | 0.42 | 0.58 | 0.37 | 0.31 | 0.19 |
| NN | | 8 | 8 | 8 | 8 | 8 | 8 |
| x̅ | TP => CP | 6.84 | 3.90 | 2.94 | 6.73 | 3.37 | 3.35 |
| s | | 0.23 | 0.34 | 0.52 | 0.26 | 0.18 | 0.35 |
| NN | | 7 | 7 | 7 | 7 | 7 | 7 |

TABLE 25
Statistical Comparison of Values as Obtained with TP and CP

| | Log RF | | | Rank of | |
|---|---|---|---|---|---|
| | Derived of | | Difference | Difference | |
| Volunteer | CP | TP | CP − TP | Without Sign | With Sign |
| 1 | 2.91 | 3.60 | −0.69 | 11 | −11 |
| 2 | 3.42 | 3.69 | −0.27 | 8 | −8 |
| 3 | 2.45 | 3.54 | −1.09 | 13 | −13 |
| 4 | 3.38 | 3.54 | −0.16 | 4 | −4 |
| 5 | 2.90 | 3.41 | −0.51 | 9 | −9 |
| 6 | 3.39 | 3.14 | 0.25 | 7 | 7 |
| 7 | 3.15 | 3.37 | −0.22 | 6 | −6 |
| 8 | 1.73 | 3.25 | −1.52 | 14 | −14 |
| 9 | 3.24 | 3.04 | 0.20 | 5 | 5 |
| 10 | 2.91 | 2.81 | 0.10 | 2 | 2 |
| 11 | 3.04 | 3.17 | −0.13 | 3 | −3 |
| 12 | 1.95 | 3.60 | −1.65 | 15 | −15 |
| 13 | 3.67 | 3.69 | −0.02 | 1 | −1 |
| 14 | 2.84 | 3.72 | −0.88 | 12 | −12 |
| 15 | 2.92 | 3.44 | −0.52 | 10 | −10 |

| | |
|---|---|
| RF | Reduction Factor |
| CP | Control Product |
| TP | Test Product |

| | |
|---|---|
| Rank Sum (+): | 14 |
| Rank Sum (−): | 106 |

TABLE 26

| N | Level of Significance (Directional Test) |
|---|---|
| Number of Pairs | 0.01 |
| Difference Unequal (0) | |
| 12 | 9 |
| 13 | 12 |
| 14 | 15 |
| 15 | 19 |

According to EN 1499 the batch LES 17E-1/24.01.2023 of the product FC923975 (the formula of Table 10), is suitable for medical hygienic hand wash by the following application: Rub 1.5 ml of the undiluted product FC923975 onto the pre-wetted hands during 30 seconds, rinse for 10 seconds.

The embodiments being thus described, it will be obvious that the same may be varied in many ways. Such variations are not to be regarded as a departure from the spirit and scope of the disclosure and all such modifications are intended to be included within the scope of the following claims.

What is claimed is:

1. An antimicrobial hand wash composition comprising:
an organic acid;
a preservative; and
a microbial synergist.

2. The composition of claim 1, wherein the organic acid comprises a carboxylic acid, a sulfonic acid, or a combination thereof.

3. The composition of claim 2, wherein the carboxylic acid comprises lactic acid, citric acid, acetic acid, formic acid, oxalic acid, uric acid, malic acid, tartaric acid, gluconic acid, glucaric acid, ascorbic acid, glutamic acid, levulinic acid, heptanoic acid, octanoic acid, nonanoic acid, decanoic acid, dodecanoic acid, tetradecanoic acid, hexadecenoic acid, octadecanoic acid, benzoic acid, icosanoic acid, or a combination thereof.

4. The composition of claim 2, wherein the sulfonic acid comprises methanesulfonic acid, ethanedisulfonic acid, 2-ethanesulfonic acid, 2-aminoethanesulfonic acid, toluenesulfonic acid, sodium tetradecyl sulfate, 2-Acrylamido-2-methylpropane sulfonic acid (AMPS), or a combination thereof.

5. The composition of claim 1, wherein the preservative comprises a carboxylic acid salt preservative, a phenolic compound, or a combination thereof.

6. The composition of claim 5, wherein the carboxylic acid salt preservative is a salt of benzoic acid, propanoic acid, sorbic acid, methanoic acid, ethanoic acid, or a combination thereof.

7. The composition of claim 1, wherein the preservative comprises calcium proprionate, sodium proprionate, potassium sorbate, sodium benzoate, sodium sorbate, or a combination thereof.

8. The composition of claim 1, wherein the microbial synergist comprises an alkyl aryl alcohol.

9. The composition of claim 8, wherein the alkyl aryl alcohol comprises a primary aryl alcohol, secondary aryl alkyl alcohol, tertiary aryl alkyl alcohol, or a combination thereof.

10. The composition of claim 8, wherein the alkyl aryl alcohol comprises anisyl alcohol, 2-methoxybenzyl alcohol, benzyl alcohol, 2-benzylheptanol, 2-(4-tert butyl phenyl) ethanol, 2,2-dimethyl-3-phenylpropanol, p-isopropylbenzyl alcohol, 3-(p-Isopropyl)phenyl-2-methyl-1-propanol, β-methoxy benzeneethanol, β-methylpenethyl alcohol, 2-(3-methylphenoxy)ethanol, 2-(3-methylphenyl)ethanol, 2-methyl-4-phenylpentanol, 2-methyl-5-phenylpentanol, 3-methyl-5-phenylpentanol, phenethyl alcohol, 2-phenoxyethanol, 5-phenylpentanol, phenylpropanol, p-tolyl alcohol, o-tolylethanol, 2-p-tolylethanol, β,β,3-trimethyl benzenepropanol, α-Isobutylphenethyl alcohol, α-methylbenzyl alcohol, 3-Methyl-1-phenylbutan-2-ol, 4-Phenyl-3-buten-2-ol, α-propylphenethyl alcohol, benzhydrol, α,α-dimethylphenethyl alcohol, 2-methyl-4-phenyl-2-butanol, 1-phenyl-3-methyl-3-pentanol, 2-phenyl-2-propanol, p-α,α-trimethylbenzyl alcohol, α,α,4-trimethylphenethyl alcohol, or a combination thereof.

11. The composition of claim 1, further comprising an anionic surfactant, a nonionic surfactant, amphoteric surfactant, or a combination thereof.

12. The composition of claim 11, wherein
(i) the anionic surfactant comprises a sulfate, sulfonate, or sulfolaurate;
(ii) the nonionic surfactant comprises a glucosamide, EO/PO block copolymer, polyhydroxyfatty acid amide, fatty alcohol, alkylpolysaccharide, or alkoxylated amine;
(iii) the amphoteric surfactant comprises cocamidopropyl betaine (CAPB)/coconut alkyl amidopropyl dimethyl betaine, hexadecyl dimethyl betaine, C₁₂₋₁₄ acylamidopropylbetaine, C₈₋₁₄ acylamidohexyldiethyl betaine, C₁₄₋₁₆ acylmethylamidodiethylammonio-1-carboxybutane, C₁₆₋₁₈ acylamidodimethylbetaine, C₁₂₋₁₆ acylamidopentanediethylbetaine, or C₁₂₋₁₆ acylmethylamidodimethylbetaine; or
(iv) a combination thereof.

13. The composition of claim 1, further comprising a solvent, and wherein the solvent comprises water, an alcohol, an ester, a glycol ether, an amide, a hydrocarbon, or a combination thereof.

14. The composition of claim 1, further comprising an additional functional ingredient comprising a humectant, thickener, emollient, pH modifier, filler, carrier, additional microbial synergist, additional preservative, colorant, dispersant, stabilizing agent, or a combination thereof.

15. The composition of claim 1, wherein the composition comprises from about 0.01 wt. % to about 15 wt. % of the organic acid, from about 0.1 wt. % to about 10 wt. % of the preservative, and from about 0.1 wt. % to 15 wt. % of the microbial synergist.

16. A method of treating a target comprising:
contacting an antimicrobial composition with the target;
wherein the antimicrobial composition comprises an organic acid, a preservative, and a microbial synergist; and
wherein the contacting lasts for a sufficient time to provide an at least 2 log₁₀ reduction in a microbial population on the target.

17. The method of claim 16, further comprising a step of diluting the antimicrobial composition with water.

18. The method of claim 16, wherein the target is a human skin surface, a non-human skin surface, or combination thereof.

19. The method of claim 16, wherein the microbial population comprises Escherichia coli, Pseudomonas aeruginosa, Staphylococcus aureus, methicillin-resistant Staphylococcus aureus (MRSA), Candida albicans, Salmonella enterica, Listeria monocytogenes, a human calicivirus (HuCV) a norovirus, or a combination thereof.

20. The method of claim 16, further comprising a step of rinsing the target.
